(19) United States
(12) Patent Application Publication
(10) Pub. No.: US 2026/0036730 A1
(43) Pub. Date: Feb. 5, 2026

(54) LIGHT ABSORPTION FILTER, OPTICAL FILTER, MANUFACTURING METHOD FOR OPTICAL FILTER, ORGANIC ELECTROLUMINESCENT DISPLAY DEVICE, INORGANIC ELECTROLUMINESCENT DISPLAY DEVICE, AND LIQUID CRYSTAL DISPLAY DEVICE

(71) Applicant: FUJIFILM Corporation, Tokyo (JP)

(72) Inventor: Nobutaka FUKAGAWA, Minamiashigara-shi (JP)

(73) Assignee: FUJIFILM Corporation, Tokyo (JP)

(21) Appl. No.: 19/353,641

(22) Filed: Oct. 9, 2025

Related U.S. Application Data
(63) Continuation of application No. PCT/JP2024/014884, filed on Apr. 12, 2024.

(30) Foreign Application Priority Data
Apr. 19, 2023 (JP) 2023-068488
Aug. 31, 2023 (JP) 2023-141858

(51) Int. Cl. G02B 5/22; G02F 1/1335

(52) U.S. Cl. CPC G02B 5/22; G02F 1/133514

(57) ABSTRACT

There are provided a light absorption filter including a wavelength selective absorption layer containing a resin A having an acid group, and a dye, and an adjacent layer directly disposed on at least one surface of the wavelength selective absorption layer, in which the adjacent layer contains a resin having a basic group, an optical filter using the light absorption filter, a manufacturing method for the optical filter, and an OLED display device, an inorganic EL display device, and a liquid crystal display device, each of which includes the optical filter.

### CROSS-REFERENCE TO RELATED APPLICATIONS

This application is a Continuation of PCT International Application No. PCT/JP2024/014884 filed on Apr. 12, 2024, which claims priority under 35 U.S.C. § 119 (a) to Japanese Patent Application No. 2023-068488 filed in Japan on Apr. 19, 2023 and Japanese Patent Application No. 2023-141858 filed in Japan on Aug. 31, 2023. Each of the above applications is hereby expressly incorporated by reference, in its entirety, into the present application.

### BACKGROUND OF THE INVENTION

### 1. Field of the Invention

The present invention relates to a light absorption filter, an optical filter, a manufacturing method for the optical filter, an organic electroluminescent display device, an inorganic electroluminescent display device, and a liquid crystal display device.

### 2. Description of the Related Art

As image display devices, an organic electroluminescent (OLED) display device, an inorganic electroluminescent display device (inorganic EL display device), a liquid crystal display device, and the like have been used in recent years.

A liquid crystal display device is widely used year by year as a space-saving image display device with low power consumption. The liquid crystal display device is a non-light emitting element in which the liquid crystal panel itself displaying an image does not emit light, and thus the liquid crystal display device includes a backlight unit which is disposed on a rear surface of the liquid crystal panel and supplies light to the liquid crystal panel.

The OLED display device is a device that displays an image by utilizing self-luminescence of OLED elements. Therefore, the OLED display device has advantages that a high contrast ratio, a high color reproducibility, a wide viewing angle, a high-speed responsiveness, and a reduction in thickness and weight can be achieved, as compared with various display devices such as a liquid crystal display device and a plasma display device. In addition to these advantages, in terms of flexibility, research and development are being actively carried out as a next-generation display device.

The inorganic EL display device is a device that displays an image by utilizing self-luminescence of inorganic EL elements as a fluorescent material, instead of the OLED elements in the OLED display device. As a result of recent research, it is expected that a display device more excellent than the OLED display device in terms of a large screen size, a longer service life, and the like can be realized.

In the development of an image display device, there is known a technique of incorporating a light absorption filter as a configuration.

For example, WO2021/066082A discloses a laminate obtained by directly arranging a gas barrier layer on at least one surface of a wavelength selective absorption layer containing a dye having a main absorption wavelength band in a specific wavelength range and an antifading agent for a dye, where the gas barrier layer consists of a crystalline resin and has a thickness of 0.1 μm to 10 μm and an oxygen permeability of 60 cc/m²·day·atm or less. According to WO2021/066082A, in a case where this laminate is used as a means for antireflection of external light in an OLED display device instead of a circularly polarizing plate, it is said that excellent light resistance is exhibited and productivity is also excellent.

Regarding another form of the light absorption filter that is incorporated in an image display device, research has been also carried out on an optical filter having both a light absorptive portion having a light absorption effect and a portion in which the light absorbability has been eliminated (hereinafter, also simply referred to as a “light absorbability-eliminated portion”), which is obtained by eliminating the light absorbability of a desired portion. In particular, in a form in which an optical filter is used by being incorporated in an image display device, light absorption characteristics close to being colorless are required at a light absorbability-eliminated portion in the optical filter.

For example, WO2021/132674A describes a light absorption filter containing a resin, a dye containing a squaraine-based coloring agent represented by General Formula (1) described in WO2021/132674A, and a compound that generates a radical upon ultraviolet irradiation. According to the light absorption filter described in WO2021/132674A, it is said that a high decolorization rate is exhibited upon ultraviolet irradiation, and absorption derived from a new coloration structure (hereinafter, also referred to as “secondary absorption”) associated with the decomposition of the dye upon ultraviolet irradiation hardly occurs, whereby a high decolorization property can be obtained.

### SUMMARY OF THE INVENTION

As a result of studies conducted by the present inventors, it has been found that there is room for improvement in the adhesiveness between the dye-containing layer and the adjacent layer in the laminate described in WO2021/066082A and the light absorption filter described in WO2021/132674A.

That is, an object of the present invention is to provide a light absorption filter having excellent adhesiveness.

In addition, an object of one embodiment of the present invention is to provide a light absorption filter having excellent adhesiveness and having decolorization properties, an optical filter using the light absorption filter, an optical filter having a light absorptive portion and a light absorbability-eliminated portion at a desired position, a manufacturing method for the optical filter, and an OLED display device, an inorganic electroluminescent display device, and a liquid crystal display device, each of which includes the optical filter.

As a result of intensive studies in view of the above-described problems, the present inventors have found that, in a light absorption filter including a wavelength selective absorption layer containing a resin A having an acid group, and a dye, and an adjacent layer directly disposed on at least one surface of the wavelength selective absorption layer, by achieving a configuration of the light absorption filter in which the adjacent layer contains a resin having a basic group, the adhesiveness between the wavelength selective absorption layer and the adjacent layer is effectively enhanced. Further studies have been carried out based on these findings, whereby the present invention has been completed.

That is, the above object has been achieved by the following means.

<1>

A light absorption filter comprising:
a wavelength selective absorption layer containing a resin A having an acid group, and a dye; and
an adjacent layer directly disposed on at least one surface of the wavelength selective absorption layer,
wherein the adjacent layer contains a resin having a basic group.
   <2>

The light absorption filter according to <1>,
in which the wavelength selective absorption layer contains a compound B that forms a hydrogen bond with the acid group contained in the resin A and generates a radical upon ultraviolet irradiation.
   <3>

The light absorption filter according to <2>,
in which in the light absorption filter, the dye is chemically changed to be decolorized upon the ultraviolet irradiation.
   <4>

An optical filter that is obtained by subjecting the light absorption filter according to <2> or <3> to mask exposure by ultraviolet irradiation.

<5>

An organic electroluminescent display device, an inorganic electroluminescent display device, or a liquid crystal display device, comprising:
the optical filter according to <4>.
   <6>

The organic electroluminescent display device, the inorganic electroluminescent display device, or the liquid crystal display device according to <5>,
in which a layer that inhibits light absorption of the compound B that generates the radical upon the ultraviolet irradiation is provided on a viewer side with respect to the optical filter.
   <7>

A manufacturing method for an optical filter, comprising:
irradiating the light absorption filter according to <2> or <3> with an ultraviolet ray to carry out mask exposure.

In the present invention, in a case where there are a plurality of substituents, linking groups, and the like (hereinafter, referred to as substituents and the like) represented by specific reference numerals or formulae, or in a case where a plurality of substituents and the like are defined at the same time, the respective substituents and the like may be the same as or different from each other unless otherwise specified. The same applies to the definition of the number of substituents or the like. In addition, in a case where a plurality of substituents and the like come close to each other (particularly in a case where the substituents and the like are adjacent to each other), the substituents and the like may also be linked to each other to form a ring unless otherwise specified. In addition, unless otherwise specified, rings, for example, alicyclic rings, aromatic rings, and heterocyclic rings may be further fused to form a fused ring.

In the present invention, unless otherwise specified, the wavelength selective absorption layer may contain one kind or may contain two or more kinds of each of the components (the resin A having an acid group, and the dye), which constitute the wavelength selective absorption layer in the light absorption filter, and the components that may be contained in the wavelength selective absorption layer (the resin other than the resin A, the compound B that forms a hydrogen bond with the acid group contained in the resin A and generating a radical upon ultraviolet irradiation, another component which may be appropriately contained, and the like). In addition, each of the components (the resin having a basic group) constituting the adjacent layer in the light absorption filter according to an aspect of the present invention and the components (other components which may be appropriately contained) which may be contained in the adjacent layer may be contained in one kind or two or more kinds in the adjacent layer. The same also applies to the wavelength selective absorption layer and the adjacent layer in the optical filter that is produced by using the light absorption filter according to the aspect of the present invention.

In the optical filter according to the aspect of the present invention, the wavelength selective absorption layer in the light absorption filter according to the aspect of the present invention has a light absorbability-eliminated portion formed by ultraviolet irradiation. Unless otherwise specified, the description regarding the light absorption filter according to the aspect of the present invention can preferably apply to the optical filter according to the aspect of the present invention, except that it has this light absorbability-eliminated portion.

In the present invention, in a case where an E type double bond and a Z type double bond are present in a molecule, the double bond may be any one thereof or may be a mixture thereof, unless otherwise specified.

In the present invention, in the coloring agent (dye) represented by each General Formula, a cation is present in a delocalized manner, and thus a plurality of tautomer structures are present. Therefore, in the present invention, in a case where at least one tautomer structure of a certain coloring agent matches with each general formula, the certain coloring agent shall be a coloring agent represented by the general formula. Therefore, a coloring agent represented by a specific general formula can also be said to be a coloring agent having at least one tautomer structure that can be represented by the specific general formula. In the present invention, a coloring agent represented by a general formula may have any tautomer structure as long as at least one tautomer structure of the coloring agent matches with the general formula.

In the present invention, the representation of a compound (including a complex) is used to have a meaning including not only the compound itself but also a salt thereof, and an ion thereof. In addition, it is meant to include those in which a part of the structure is changed within a range where the effect of the present invention is not impaired. Furthermore, it is meant that a compound, which is not specified to be substituted or unsubstituted, may have any substituent within a range where the effect of the present invention is not impaired. The same applies to the definition of a substituent or a linking group.

In addition, in the present invention, the numerical value range indicated by using “to” means a range including the numerical values before and after “to” as the lower limit value and the upper limit value, respectively.

In the present invention, the “composition” includes a mixture in which the component concentration varies within a range in which a desired function is not impaired, in addition to a mixture in which the component concentration is constant (respective components are uniformly dispersed).

In the present invention, the description of “having a main absorption wavelength band in a wavelength range of XX to YY nm” means that a wavelength at which the maximal absorption is exhibited (that is, the maximal absorption wavelength) is present in the wavelength range of XX to YY nm. Therefore, in a case where the maximal absorption wavelength is present in the above-described wavelength range, the entire absorption band including this wavelength may be in the above-described wavelength range or may also extend up to the outside of the above-described wavelength range. In addition, in a case where there are a plurality of maximal absorption wavelengths, it suffices that a maximal absorption wavelength at which the highest absorbance is exhibited is present in the above-described wavelength range. That is, the maximal absorption wavelength other than the maximal absorption wavelength at which the highest absorbance is exhibited may be present either inside or outside the above-described wavelength range of XX to YY nm.

In the present invention, the main absorption wavelength band of a dye is the main absorption wavelength band of the dye, which is measured in the state of being a light absorption filter. Specifically, in the examples described later, it is measured in a state of being a base material-attached light absorption filter under the conditions described in the section of the absorbance of the light absorption filter.

In the present invention, “(meth)acrylate” represents either or both of acrylate and methacrylate, “(meth)acrylic acid” represents any one or both of acrylic acid and methacrylic acid and “(meth)acryloyl” represents any one or both of acryloyl and methacryloyl.

The light absorption filter according to the aspect of the present invention exhibits excellent adhesiveness.

In addition, the optical filter according to the aspect of the present invention, which is obtained by using the light absorption filter having excellent adhesiveness and having a decolorization property, which is an embodiment of the light absorption filter according to the aspect of the present invention, has a light absorptive portion and a light absorbability-eliminated portion at a desired position.

The OLED display device, the inorganic electroluminescent display device, and the liquid crystal display device according to the aspect of the present invention comprise the optical filter according to the aspect of the present invention.

In addition, according to the manufacturing method according to the aspect of the present invention, it is possible to obtain the optical filter according to the aspect of the present invention, which has a light absorptive portion and a light absorbability-eliminated portion at a desired position.

### BRIEF DESCRIPTION OF THE DRAWINGS

FIG. 1 is a schematic view illustrating an outline of one embodiment of a liquid crystal display device having an optical filter according to the present invention.

FIG. 2 is a schematic cross-sectional view showing an outline of an embodiment of a light absorption filter according to the present invention.

### DESCRIPTION OF THE PREFERRED EMBODIMENTS

### [Light Absorption Filter]

The light absorption filter according to the embodiment of the present invention is a light absorption filter including a wavelength selective absorption layer containing a resin A having an acid group, and a dye, and an adjacent layer directly disposed (in contact with) on at least one surface of the wavelength selective absorption layer, in which the adjacent layer contains a resin having a basic group. The light absorption filter according to the embodiment of the present invention having such a configuration can exhibit excellent interlayer adhesiveness. The reason for this is not clear, but it is considered that the resin having a basic group, which is added to the adjacent layer, is unevenly distributed in the adjacent layer in the vicinity of the interface between the wavelength selective absorption layer and the adjacent layer, and forms a hydrogen bond with the acid group contained in the resin A contained in the wavelength selective absorption layer, thereby contributing to the expression of excellent adhesiveness. Such an effect is supported by Examples described later.

In the wavelength selective absorption layer in the light absorption filter according to the embodiment of the present invention, the dye is dispersed (preferably dissolved) in the resin A having an acid group, whereby the light absorption filter and the wavelength selective absorption layer are made to be layers exhibiting a specific absorption spectrum derived from the dye. This dispersion may be any type of dispersion, such as a random type or a regular type.

In addition, in a case where the light absorption filter according to the embodiment of the present invention contains a resin other than the resin A having an acid group, the dye may be dispersed (preferably dissolved) in the resin A having an acid group and/or the resin other than the resin A having an acid group.

In addition, in a case where the light absorption filter according to the embodiment of the present invention has a configuration in which the dye can be decolorized by ultraviolet rays (the configuration comprising decolorization properties), the light absorption filter according to the embodiment of the present invention has characteristics that the dye can be chemically changed and decolorized by ultraviolet irradiation. As a result, by carrying out mask exposure by ultraviolet irradiation, it is possible to obtain the optical filter according to the embodiment of the present invention, which has both the light absorptive portion having a light absorption effect and the light absorbability-eliminated portion.

Examples of the configuration of the light absorption filter in which a dye is capable of being decolorized with ultraviolet rays include a form in which the wavelength selective absorption layer in the light absorption filter according to the embodiment of the present invention contains a compound that generates a radical upon ultraviolet irradiation, as described in WO2021/132674A.

Among these, preferred examples thereof include a light absorption filter which contains a wavelength selective absorption layer containing a dye, a resin A having an acid group, and a compound B that forms a hydrogen bond with the acid group contained in the resin A and generates a radical upon ultraviolet irradiation, and an adjacent layer disposed on at least one surface of the wavelength selective absorption layer, in which the adjacent layer contains a resin having a basic group (hereinafter, also referred to as “light absorption filter I according to the embodiment of the present invention”).

In the wavelength selective absorption layer, the “compound B that forms a hydrogen bond with the acid group contained in the resin A and generates a radical upon ultraviolet irradiation” is dispersed (preferably dissolved) in the resin A by forming a hydrogen bond with the acid group contained in the resin A, and in a case where ultraviolet irradiation is performed, the radical is generated, and the generated radical reacts with the nearby dye, whereby the radical is likely to react with the dye, and the dye can be more efficiently faded and decolorized.

As described above, the wavelength selective absorption layer in the light absorption filter I according to the embodiment of the present invention contains a dye, a resin A having an acid group, and a compound B that forms a hydrogen bond with the acid group contained in the resin A and generates a radical upon ultraviolet irradiation. The light absorption filter I according to the embodiment of the present invention, which has the wavelength selective absorption layer having such a configuration can exhibit, as described above, an excellent decolorization property in addition to exhibiting excellent adhesiveness even in a case of carrying out ultraviolet irradiation at room temperature (which means 10° C. to 30° C.), which is a mild environment. The presumable reason for this is considered to be as follows.

It is considered that a radical species having a strong reducing power is generated by ultraviolet irradiation in the wavelength selective absorption layer in the light absorption filter I according to the embodiment of the present invention. Therefore, even in a case where the dye is irradiated with ultraviolet rays under a mild temperature condition such as room temperature, the dye is reduced and decomposed, and thus the dye is faded and decolorized. In particular, in a case where the dye contained in the wavelength selective absorption layer in the light absorption filter I according to the embodiment of the present invention contains at least one of an azo-based coloring agent represented by any of General Formulae (i) to (iv) or an indoaniline-based coloring agent represented by General Formula (v) described later, the light absorption filter I can be decolorized without causing secondary absorption associated with the decomposition of the dye even in a case of being irradiated with ultraviolet rays at room temperature (meaning 10° C. to 30° C.), which is a mild environment.

The reason for this is presumed as follows: the azo-based coloring agent represented by General Formula (i) described later exhibits excellent decolorization properties since a hydroxy group on a pyridine ring bonded to an azo group (—N═N—) contributes to the generation of radical species, and thus an excellent decolorization rate is obtained even in a case where the ultraviolet irradiation is carried out under a mild temperature condition such as room temperature, and the azo-based coloring agent itself represented by General Formula (i) hardly causes secondary absorption associated with the decomposition of the dye. The azo-based coloring agent represented by any of General Formulae (ii) to (iv) has a structure in which an electron donating group (an amino group) is substituted at one terminal of a chromophore and an electron withdrawing group (a thiazole group or an isothiazole group) is substituted at the other terminal thereof. In general, the effect of stabilizing a radical by substituting both an electron donating group and an electron withdrawing group with respect to a radical center is known as a “captodative effect”, which is described, for example, on pages 148 to 154 of Acc. Chem. Res., vol. 18 (1985). It is considered that since the azo-based coloring agent represented by any of General Formulae (ii) to (iv) is also likely to generate a radical due to the “captodative effect” described above, an excellent decolorization rate is obtained in a case of being irradiated with ultraviolet rays. In addition, it is considered that since the indoaniline-based coloring agent represented by General Formula (v) also has a structure in which an electron donating group (an amino group) is substituted at one terminal of a chromophore and an electron withdrawing group (a carbonyl group) is substituted at the other terminal thereof, an excellent decolorization rate is obtained due to the “captodative effect” described above, even in a case where the ultraviolet irradiation is carried out under a mild temperature condition such as room temperature, and the azo-based coloring agent itself represented by any of General Formulae (ii) to (iv) and the indoaniline-based coloring agent itself represented by General Formula (v) hardly cause secondary absorption associated with the decomposition of the dye, excellent decolorization properties are exhibited.

On the other hand, as the dye having a main absorption wavelength band in a wavelength range of approximately 400 to 500 nm among the dyes having a main absorption wavelength band in a wavelength range of 400 to 700 nm described in WO2021/132674A, a benzylidene-based coloring agent represented by General Formula (V) or a cinnamylidene-based coloring agent, which is described in WO2021/132674A, is described. However, in a case where a light absorption filter containing this coloring agent is subjected to ultraviolet irradiation at room temperature (which means 10° C. to 30° C.), which is a mild environment, the decolorization rate is as low as 84% as described in Comparative Example No. c202 in Reference Example described later, and the decolorization properties at room temperature are deteriorated. Due to containing an azo-based coloring agent represented by General Formula (i) described later instead of the benzylidene-based coloring agent represented by General Formula (V) or the cinnamylidene-based coloring agent, which is described in WO2021/132674A, the light absorption filter according to the embodiment of the present invention has a main absorption wavelength band in a wavelength range of approximately 400 to 500 nm, and can exhibit excellent decolorization properties even in a case of being subjected to ultraviolet irradiation at room temperature (which means 10° C. to 30° C.), which is a mild environment.

In addition, due to containing the azo-based coloring agent represented by any of General Formulae (ii) to (iv) described later or the indoaniline-based coloring agent represented by General Formula (v), the light absorption filter according to the embodiment of the present invention has a main absorption wavelength band in a wavelength range of approximately 450 to 700 nm and can exhibit excellent decolorization properties equivalent to those of a light absorption filter containing the squaraine-based coloring agent represented by General Formula (1) described in WO2021/132674A, even in a case of being subjected to ultraviolet irradiation at room temperature (which means 10° C. to 30° C.), which is a mild environment.

The wavelength selective absorption layer and the adjacent layer in the light absorption filter according to the embodiment of the present invention will be described in order.

### [Wavelength Selective Absorption Layer]

The wavelength selective absorption layer in the light absorption filter according to the embodiment of the present invention contains a resin A having an acid group, and a dye.

### <Dye>

The dye contained in the wavelength selective absorption layer is not particularly limited, and for example, a dye having a main absorption wavelength band in a wavelength range of 400 to 700 nm can be used.

The dye contained in the wavelength selective absorption layer preferably contains at least one of an azo-based coloring agent represented by any one of General Formulae (i) to (iv) or an indoaniline-based coloring agent represented by General Formula (v), and more preferably contains at least one of an azo-based coloring agent represented by General Formula (i) or an indoaniline-based coloring agent represented by General Formula (v).

The azo-based coloring agent represented by General Formula (i) described later is a dye having a main absorption wavelength band in a wavelength range of approximately 400 to 500 nm, the azo-based coloring agent represented by any of General Formulae (ii) to (iv) described later is a dye having a main absorption wavelength band in a wavelength range of approximately 450 to 600 nm, and the indoaniline-based coloring agent represented by General Formula (v) described later is a dye having a main absorption wavelength band in a wavelength range of approximately 580 to 700 nm.

Each of the coloring agents of the azo-based coloring agent represented by General Formula (i), the azo-based coloring agent represented by General Formula (ii), the azo-based coloring agent represented by General Formula (iii), the azo-based coloring agent represented by General Formula (iv), and the indoaniline-based coloring agent represented by General Formula (v), which may be contained in the wavelength selective absorption layer, may be one kind or may be two or more kinds.

The wavelength selective absorption layer can also contain a dye other than the above-described dye.

### (1) an Azo-Based Coloring Agent Represented by General Formula (i)

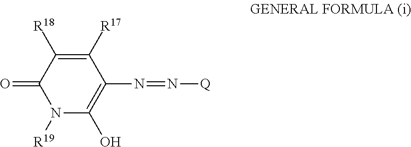

In the formula, R¹⁷ and R¹⁸ each independently represent a hydrogen atom or a monovalent substituent.
R¹⁹ represents a hydrogen atom, an aliphatic group, an aryl group, a heterocyclic group, a carbamoyl group, an alkoxycarbonyl group, an aryloxycarbonyl group, an acyl group, an alkylsulfonyl group, an arylsulfonyl group, or a sulfamoyl group.
Q represents a diazo component residue.

However, R¹⁷ to R¹⁹ and Q do not have a squaraine structure.

The above-described squaraine structure means a structure of a squaraine-based coloring agent. The squaraine-based coloring agent is a coloring agent having a structure that has a skeleton derived from squaric acid in a central part of a π-conjugated system. Examples thereof include a squaraine-based coloring agent represented by General Formula (1) described in WO2021/132674A.

Examples of the monovalent substituent that can be adopted as R¹⁷ and R¹⁸ include a halogen atom, an aliphatic group, an aryl group, a heterocyclic group, a cyano group, a carboxy group, a carbamoyl group, an aliphatic oxycarbonyl group, an aryloxycarbonyl group, an acyl group, a hydroxy group, an aliphatic oxy group, an aryloxy group, an acyloxy group, a carbamoyloxy group, a heterocyclic oxy group, an amino group (—NH₂), an aliphatic amino group, an arylamino group, a heterocyclic amino group, an acylamino group, a carbamoylamino group, a sulfamoylamino group, an aliphatic oxycarbonylamino group, an aryloxycarbonylamino group, an aliphatic sulfonylamino group, an arylsulfonylamino group, a nitro group, an aliphatic thio group, an arylthio group, an aliphatic sulfonyl group, an arylsulfonyl group, a sulfamoyl group, a sulfo group, an imide group, and a heterocyclic thio group. Among these, an aliphatic group, an aryl group, a heterocyclic group, a cyano group, a carbamoyl group, an aliphatic oxycarbonyl group, an aryloxycarbonyl group, an acyl group, an aliphatic oxy group, an aryloxy group, an aliphatic amino group, or an arylamino group is preferable mainly from the viewpoint of imparting solubility.

The substituents that can be adopted as R¹⁷ and R¹⁸ may be further substituted.

The aliphatic group that can be adopted as R¹⁷ to R¹⁹ may further have a monovalent substituent, may be saturated or unsaturated, and may be cyclic. Specific examples thereof include an alkyl group, a substituted alkyl group, an alkenyl group, a substituted alkenyl group, an alkynyl group, a substituted alkynyl group, an aralkyl group, and a substituted aralkyl group. The total number of carbon atoms in the aliphatic group is preferably 1 to 30 and more preferably 1 to 16. Specific examples of the aliphatic group include a methyl group, an ethyl group, a butyl group, an isopropyl group, a t-butyl group, a hydroxyethyl group, a methoxyethyl group, a cyanoethyl group, a trifluoromethyl group, a 3-sulfopropyl group, a 4-sulfobutyl group, a 2-(2-hydroxyethoxy)ethyl group, a 2-(2-(acetyloxy) ethoxy)ethyl group, a cyclohexyl group, a benzyl group, a 2-phenethyl group, a vinyl group, and an allyl group.

It is noted that Examples of the monovalent substituent which may be contained include the monovalent substituents that can be adopted as R¹⁷ and R¹⁸, and the same applies to the following description regarding the monovalent substituent which may be contained. The monovalent substituent which may be contained is, for example, preferably an alkoxy group, an acyloxy group, or a hydroxy group. In addition, this substituent may further have a substituent, and preferred examples thereof include an alkoxy group, an acyloxy group, and a hydroxy group.

The aryl group that can be adopted as R¹⁷ to R¹⁹ may further have a monovalent substituent, and the aryl group is preferably an aryl group having a total number of carbon atoms of 6 to 30, and more preferably an aryl group having a total number of carbon atoms of 6 to 16. Specific examples thereof include a phenyl group, a 4-tolyl group, a 4-methoxyphenyl group, a 2-chlorophenyl group, a 3-(3-sulfopropylamino)phenyl group, a 4-sulfamoylphenyl group, a a 4-(ethoxyethylsulfamoyl)phenyl group, and 3-(dimethylcarbamoyl)phenyl group.

The heterocyclic group that can be adopted as R¹⁷ to R¹⁹ may be a saturated or unsaturated aliphatic ring group or may be an aromatic ring group, and it is preferably an aromatic heterocyclic group. Examples of the ring-constituting atom constituting the heterocyclic group include those containing at least any one of a heteroatom such as a nitrogen atom, a sulfur atom, or an oxygen atom, where the heterocyclic group may further have a monovalent substituent. The heterocyclic group is preferably a heterocyclic group having a total number of carbon atoms of 1 to 30, and more preferably a heterocyclic group having a total number of carbon atoms of 1 to 15. Specific examples thereof include a 2-pyridyl group, a 2-thienyl group, a 2-thiazolyl group, a 2-benzothiazolyl group, a 2-benzoxazolyl group, and a 2-furyl group.

The carbamoyl group that can be adopted as R¹⁷ to R¹⁹ includes, in addition to an unsubstituted carbamoyl group (—CONH₂), a carbamoyl group substituted with an aliphatic group, an aryl group, or the like.

The carbamoyl group that can be adopted as R¹⁷ to R¹⁹ may further have a monovalent substituent, and the carbamoyl group is preferably a carbamoyl group having a total number of carbon atoms of 1 to 30, and more preferably a carbamoyl group having a total number of carbon atoms of 1 to 16. Specific examples thereof include a methylcarbamoyl group, a dimethylcarbamoyl group, a phenylcarbamoyl and group, an N-methyl-N-phenylcarbamoyl group.

To the aliphatic group in the aliphatic oxycarbonyl group that can be adopted as R¹⁷ and R¹⁸, the description of the aliphatic group that can be adopted as R¹⁷ to R¹⁹ can be applied.

The aliphatic oxycarbonyl group that can be adopted as R¹⁷ and R¹⁸ may further have a monovalent substituent, may be saturated or unsaturated, or may be cyclic, and the aliphatic oxycarbonyl group is preferably an aliphatic oxycarbonyl group having a total number of carbon atoms of 2 to 30, and more preferably an aliphatic oxycarbonyl group having a total number of carbon atoms of 2 to 16. Specific examples thereof include a methoxycarbonyl group, an ethoxycarbonyl group, and a 2-methoxyethoxycarbonyl group.

The alkoxycarbonyl group that can be adopted as R¹⁹ may further have a monovalent substituent, may be saturated or unsaturated, or may be cyclic, and the alkoxycarbonyl group is preferably an alkoxycarbonyl group having a total number of carbon atoms of 2 to 30 and more preferably an alkoxycarbonyl group having a total number of carbon atoms of 2 to 16. Specific examples thereof include a methoxycarbonyl group, an ethoxycarbonyl group, and a 2-methoxyethoxycarbonyl group.

The aryloxycarbonyl group that can be adopted as R¹⁷ to R¹⁹ may further have a monovalent substituent, and it is preferably an aryloxycarbonyl group having a total number of carbon atoms of 7 to 30 and more preferably an aryloxycarbonyl group having a total number of carbon atoms of 7 to 16. Specific examples thereof include a phenoxycarbonyl group, a 4-methylphenoxycarbonyl group, and a 3-chlorophenoxycarbonyl group.

The acyl group that can be adopted as R¹⁷ to R¹⁹ includes an aliphatic carbonyl group, an arylcarbonyl group, and a heterocyclic carbonyl group, where an aspect in which the total number of carbon atoms is 1 to 30 is preferable, and an aspect in which the total number of carbon atoms is 1 to 16 is more preferable. Specific examples thereof include an acetyl group, a methoxyacetyl group, a thienoyl group, and a benzoyl group.

To the aliphatic group in the aliphatic sulfonyl group that can be adopted as R¹⁷ and R¹⁸, the description of the aliphatic group that can be adopted as R¹⁷ to R¹⁹ can be applied.

The aliphatic sulfonyl group that can be adopted as R¹⁷ and R¹⁸ may further have a monovalent substituent, may be saturated or unsaturated, or may be cyclic, where an aspect in which the total number of carbon atoms is 1 to 30 is preferable, and an aspect in which the total number of carbon atoms is 1 to 16 is more preferable. Specific examples thereof include a methanesulfonyl group, a methoxymethanesulfonyl group, and an ethoxyethanesulfonyl group.

The alkylsulfonyl group that can be adopted as R¹⁹ may further have a monovalent substituent, may be saturated or unsaturated, or may be cyclic, where an aspect in which the total number of carbon atoms is 1 to 30 is preferable, and an aspect in which the total number of carbon atoms is 1 to 16 is more preferable. Specific examples thereof include a methanesulfonyl group, a methoxymethanesulfonyl group, and an ethoxyethanesulfonyl group.

The arylsulfonyl group that can be adopted as R¹⁷ to R¹⁹ may further have a monovalent substituent, where an aspect in which the total number of carbon atoms is 6 to 30 is preferable, and an aspect in which the total number of carbon atoms is 6 to 18 is more preferable. Specific examples thereof include a benzenesulfonyl group and a toluenesulfonyl group.

The sulfamoyl group that can be adopted as R¹⁷ to R¹⁹ includes, in addition to an unsubstituted sulfamoyl group (—SO₂NH₂), a sulfamoyl group substituted with an aliphatic group, an aryl group, or the like.

The sulfamoyl group that can be adopted as R¹⁷ to R¹⁹ may further have a monovalent substituent, where an aspect in which the total number of carbon atoms is 0 to 30 is preferable, and an aspect in which the total number of carbon atoms is 0 to 16 is more preferable. Specific examples thereof include an unsubstituted sulfamoyl group, a dimethylsulfamoyl group, and a di-(2-hydroxyethyl) sulfamoyl group.

The imide group that can be adopted as R¹⁷ and R¹⁸ may further have a monovalent substituent, and it is preferably an imide group of a 5- or 6-membered ring. In addition, an aspect in which the total number of carbon atoms in the imide group is 4 to 30 is preferable, and an aspect in which the total number of carbon atoms in the imide group is 4 to 20 is more preferable. Specific examples thereof include a succinimide group and a phthalimide group.

To the aliphatic group in the aliphatic oxy group, the aliphatic amino group, the aliphatic oxycarbonylamino group, the aliphatic sulfonylamino group, and the aliphatic thio group, which can be adopted as R¹⁷ and R¹⁸, the description of the aliphatic group that can be adopted as R¹⁷ to R¹⁹ can be applied.

To the aryl group in the aryloxy group, the arylamino group, the aryloxycarbonylamino group, the arylsulfonylamino group, and the arylthio group, which can be adopted as R¹⁷ and R¹⁸, the description of the aryl group that can be adopted as R¹⁷ to R¹⁹ can be applied.

To the acyl group in the acyloxy group and the acylamino group, which can be adopted as R¹⁷ and R¹⁸, the description of the acyl group, which can be adopted as R¹⁷ to R¹⁹, can be applied.

To the carbamoyl group in the carbamoyloxy group and the carbamoylamino group, which can be adopted as R¹⁷ and R¹⁸, the description of the carbamoyl group, which can be adopted as R¹⁷ to R¹⁹, can be applied.

To the heterocyclic group in the heterocyclic oxy group, the heterocyclic amino group, and the heterocyclic thio group, which can be adopted as R¹⁷ and R¹⁸, the description of the heterocyclic group, which can be adopted as R¹⁷ to R¹⁹, can be applied.

To the sulfamoyl group in the sulfamoylamino group that can be adopted as R¹⁷ and R¹⁸, the description of the sulfamoyl group, which can be adopted as R¹⁷ to R¹⁹, can be applied.

The diazo component residue represented by Q means a residue “Q” of a diazo component “Q-NH₂”. The azo-based coloring agent represented by General Formula (i) is obtained by a diazo coupling reaction using a diazonium ion “Q-N⁺≡N” obtained from a diazo component “Q-NH₂”. In particular, from the viewpoint of the color reproducibility to be targeted, Q is preferably an aryl group or an aromatic heterocyclic group.

The aromatic hydrocarbon ring constituting the aryl group that can be adopted as Q may be a monocyclic ring or a fused ring, and it is preferably a monocyclic ring. It is preferably an aryl group having a total number of carbon atoms of 6 to 30, and more preferably an aryl group having a total number of carbon atoms of 6 to 16. Specifically, a phenyl group is preferable. The aryl group that can be adopted as Q may have a substituent, and preferred examples of the substituent that may be contained include a sulfamoyl group (preferably an alkylsulfamoyl group or a dialkylsulfamoyl group), a sulfonyl group (preferably an alkylsulfonyl group), and a cyano group.

The aromatic heterocyclic group that can be adopted as Q is an aromatic ring group containing, as a ring-constituting atom constituting a heterocyclic group, at least any one among heteroatoms such as a nitrogen atom, a sulfur atom, and an oxygen atom, where the aromatic heterocyclic group is preferably composed of a 5- or 6-membered ring. The total number of carbon atoms in the aromatic heterocyclic group is preferably 1 to 25 and more preferably 1 to 15. The aromatic heterocyclic ring constituting the aromatic heterocyclic group may be a monocyclic ring or a fused ring, and it is preferably a monocyclic ring.

Specific examples of the aromatic heterocyclic group include a pyrazole group, a 1,2,4-triazole group, an isothiazole group, a benzisothiazole group, a thiazole group, a benzothiazole group, an oxazole group, and a 1,2,4-thiadiazole group.

Examples of the azo-based coloring agent represented by General Formula (i) include the following exemplary compounds (B-12) to (B-16), (B-18), and (B-19). However, the present invention is not limited thereto.

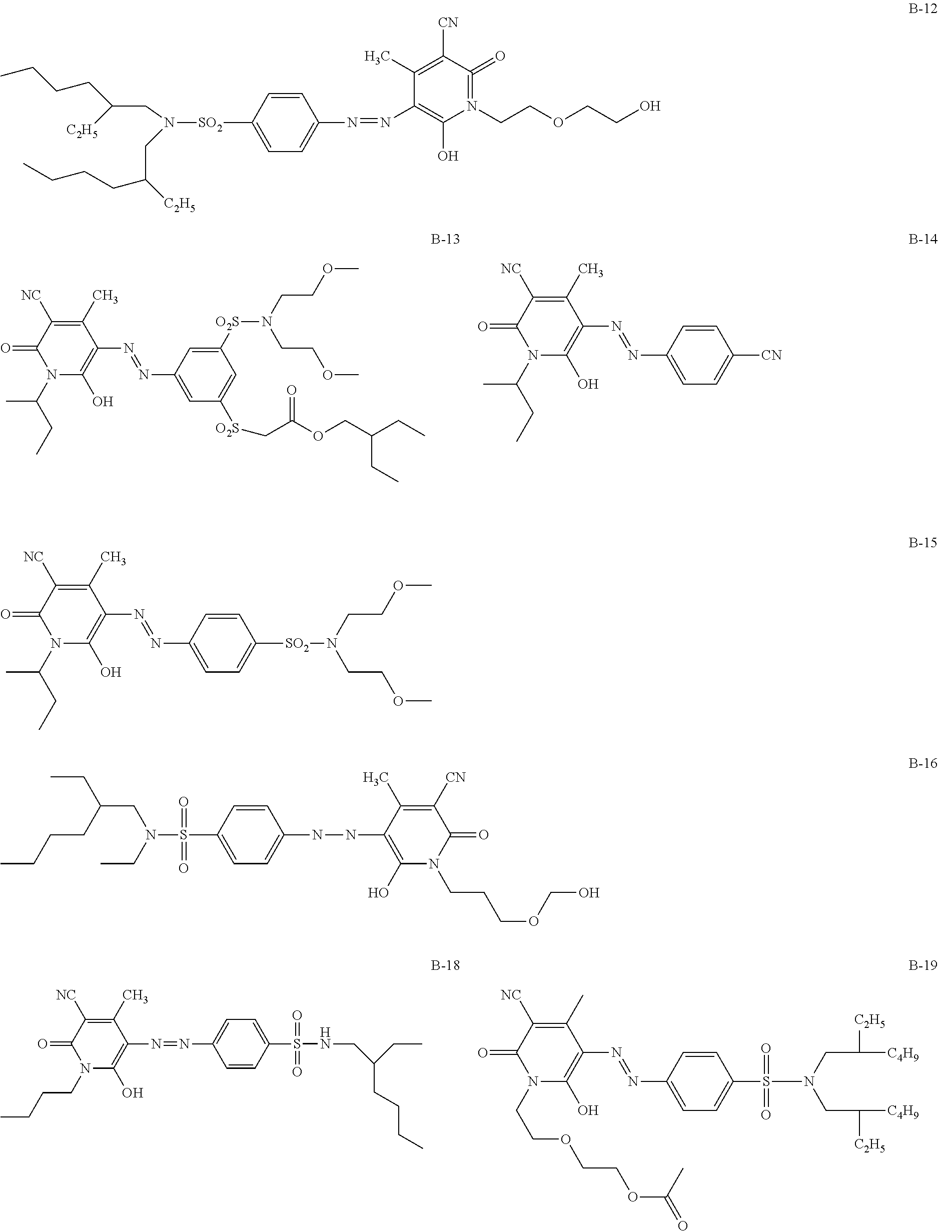

### (2) an Azo-Based Coloring Agent Represented by General Formula (ii)

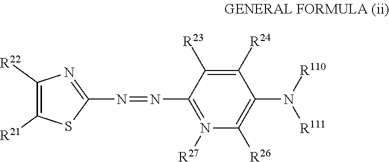

In the formula, R²¹ to R²⁴, R²⁶, and R²⁷ represent a hydrogen atom, a halogen atom, a cyano group, a nitro group, a carboxy group, a sulfo group, —OR¹⁰⁸, —SR¹⁰⁹, —NR¹¹⁰R¹¹¹, —S(═O)₂NR¹¹²R¹¹³, —C(═O)NR¹¹⁴R¹¹⁵, —NHC(═O)R¹¹⁶, —C(═O)OR¹¹⁷, —O(CH₂CH₂O)ₙR¹¹⁸, —O(CH₂CH₂S)ₙR¹¹⁹, —S(CH₂CH₂O)ₙR¹²⁰, —S(CH₂CH₂S)ₙR¹²¹, an acyclic hydrocarbon group, a monocyclic hydrocarbon group, a fused polycyclic hydrocarbon group, or a heterocyclic group.

R¹⁰⁸ to R¹²¹ represent a hydrogen atom, an acyclic hydrocarbon group, a monocyclic hydrocarbon group, a fused polycyclic hydrocarbon group, or a heterocyclic group. n is a positive integer.

It is noted that the acyclic hydrocarbon group, the monocyclic hydrocarbon group, the fused polycyclic hydrocarbon group, or the heterocyclic group may have, as a substituent, one or two or more of a halogen atom, a cyano group, a nitro group, a carboxy group, a sulfo group, —OR¹⁰⁸, —SR¹⁰⁹, —NR¹¹⁰R¹¹¹, —S(═O)₂NR¹¹²R¹¹³, —C(═O) NR¹¹⁴R¹¹⁵, —NHC(═O)R¹¹⁶, —C(═O)OR¹¹⁷, —O(CH₂CH₂O)ₙR¹¹⁸, —O(CH₂CH₂S)ₙR¹¹⁹, —S(CH₂CH₂O)ₙR¹²⁰, —S(CH₂CH₂S)ₙR¹²¹, an acyclic hydrocarbon group, a monocyclic hydrocarbon group, a fused polycyclic hydrocarbon group, and a heterocyclic group.

The acyclic hydrocarbon group that can be adopted as R²¹ to R²⁴, R²⁶, R²⁷, and R¹⁰⁸ to R¹²¹ means an acyclic alkyl group in which one hydrogen atom is removed from an acyclic alkane. However, the acyclic alkyl group may have a ring structure as a substituent. The number of carbon atoms in the acyclic alkyl group is preferably 1 to 30, more preferably 1 to 20, still more preferably 1 to 12, particularly preferably 1 to 8, and among these, it is preferably 1 to 6.

The monocyclic hydrocarbon group that can be adopted as R²¹ to R²⁴, R²⁶, R²⁷, and R¹⁰⁸ to R¹²¹ means a monocyclic cycloalkyl group, a monocyclic cycloalkenyl group, a monocyclic cycloalkynyl group, or a monocyclic aryl group, which is a group in which one hydrogen atom is removed from a monocyclic aliphatic hydrocarbon ring (which may be any of a monocyclic cycloalkane, a monocyclic cycloalkene, or a monocyclic cycloalkyne) or a monocyclic aromatic hydrocarbon ring.

The number of carbon atoms in the monocyclic cycloalkyl group, the monocyclic cycloalkenyl group, and the monocyclic cycloalkynyl group is not particularly limited as long as it is allowed in terms of the structure; however, it is more preferably 3 to 30, more preferably 3 to 20, and still more preferably 3 to 16. The number of carbon atoms in the monocyclic aryl group is more preferably 6 to 30, still more preferably 6 to 20, and even still more preferably 6 to 16.

The fused polycyclic hydrocarbon group that can be adopted as R²¹ to R²⁴, R²⁶, R²⁷, and R¹⁰⁸ to R¹²¹ means a fused polycyclic cycloalkyl group, a fused polycyclic cycloalkenyl group, a fused polycyclic cycloalkynyl group, or a fused polycyclic aryl group, which is a group in which one hydrogen atom is removed from a fused polycyclic aliphatic hydrocarbon ring (which may be any of a fused polycyclic cycloalkane, a fused polycyclic cycloalkene, or a fused polycyclic cycloalkyne) or a fused polycyclic aromatic hydrocarbon ring.

The number of carbon atoms in the fused polycyclic cycloalkyl group, the fused polycyclic cycloalkenyl group, and the fused polycyclic cycloalkynyl group is not particularly limited as long as it is allowed in terms of the structure; however, it is more preferably 8 to 30 and more preferably 8 to 20. The number of carbon atoms in the fused polycyclic aryl group is more preferably 12 to 30 and still more preferably 12 to 20.

To the heterocyclic group that can be adopted as R²¹ to R²⁴, R²⁶, R²⁷, and R¹⁰⁸ to R¹²¹ the description of the heterocyclic group that can be adopted as R¹⁷ to R¹⁹ in General Formula (i) can be applied.

n is preferably an integer of 1 to 12, more preferably an integer of 1 to 6, and still more preferably an integer of 1 to 3.

Regarding the specific group of each of the substituents in General Formula (ii), unless otherwise specified, the descriptions regarding R¹ to R⁴, R⁶, R⁷, and R⁸ to R²¹ for the compound represented by General Formula [1] described in JP1993-257180A (JP-H5-257180A) can be applied as they are to R²¹ to R²⁴, R²⁶, R²⁷, and R¹⁰⁸ to R¹²¹ respectively.

R²¹ is preferably a cyano group, a nitro group, —OR¹⁰⁸, an acyclic hydrocarbon group (preferably an acyclic alkyl group or an acyclic alkenyl group), or a heterocyclic group, more preferably a cyano group or a nitro group, or an acyclic alkyl group (preferably an alkyl group substituted with a fluorine atom) substituted with a halogen atom, and still more preferably a cyano group.

R²² is preferably a hydrogen atom, a cyano group, an acyclic hydrocarbon group (preferably an acyclic alkyl group), or a monocyclic hydrocarbon group, more preferably a hydrogen atom, an alkyl group, or an aryl group, and still more preferably an alkyl group or an aryl group.

It is noted that at least one of R²¹ or R²² is preferably a cyano group or a nitro group, or an acyclic alkyl group substituted with a halogen atom, a cyano group, or a nitro group.

R²³ is preferably a hydrogen atom, —OR¹⁰⁸, —SR¹⁰⁹, —NR¹¹⁰R¹¹¹, —C(═O)NR¹¹⁴R¹¹⁵, —NHC(═O)R¹¹⁶, —O(CH₂CH₂O)NR¹¹⁸, —O(CH₂CH₂S)ₙR¹¹⁹, —S(CH₂CH₂O)ₙR¹²⁰, —S(CH₂CH₂S)ₙR¹²¹, or an acyclic hydrocarbon group (preferably an acyclic alkyl group), more preferably a hydrogen atom, —OR¹⁰⁸, —SR¹⁰⁹, —NR¹¹⁰R¹¹¹, —NHC(═O)R¹¹⁶, or an acyclic alkyl group, and still more preferably-NHC(═O)R¹¹⁶. Here, R¹⁰⁸ to R¹¹¹, R¹¹⁴ to R¹¹⁶, and R¹¹⁸ to R¹²¹ are each preferably an acyclic alkyl group.

R²⁴ and R²⁷ are preferably a hydrogen atom.

R²⁶ is preferably a hydrogen atom, —OR¹⁰⁸, —SR¹⁰⁹, —NR¹¹⁰R¹¹¹, —NHC(═O)R¹¹⁶, —O(CH₂CH₂O)ₙR¹¹⁸, —O(CH₂CH₂S)ₙR¹¹⁹, —S(CH₂CH₂O)ₙR¹²⁰, —S(CH₂CH₂S)ₙR¹²¹, or an acyclic hydrocarbon group (preferably an acyclic alkyl group), more preferably a hydrogen atom, —OR¹⁰⁸, or —SR¹⁰⁹, and still more preferably a hydrogen atom. Here, R¹⁰⁸ to R¹¹¹, R¹¹⁶, and R¹¹⁸ to R¹²¹ are preferably an acyclic alkyl group.

In —NR¹¹⁰R¹¹¹ that is located at the ortho position with respect to R²⁴ and R²⁶, R¹¹⁰ is preferably an acyclic alkyl group, and R¹¹¹ is preferably an acyclic alkyl group and more preferably an unsubstituted acyclic alkyl group or an acyclic alkyl group having —OR¹⁰⁸, a monocyclic hydrocarbon group, or a fused polycyclic hydrocarbon group as a substituent. Here, R¹⁰⁸ is preferably a hydrogen atom or an acyclic alkyl group.

Specific examples of the coloring agent represented by General Formula (ii) include, in addition to the compounds that are used in the section of Examples described later, the compounds described in paragraphs to of JP1993-257180A (JP-H5-257180A), and the compounds described in paragraphs and [0052], the compound D-18 described in paragraph [0055], and the compound described in paragraph of JP2013-129712A. However, the present invention is not limited thereto.

(3) an Azo-Based Coloring Agent Represented by General Formula (iii)

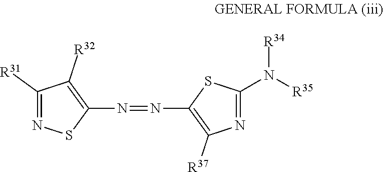

In the formula, R³¹ represents a hydrogen atom, an alkyl group, an alkoxy group, a cyano group, a carbonyl group (an alkyloxycarbonyl group or an aryloxycarbonyl group is preferable), an aromatic group, or a heterocyclic group.

R³² represents a hydrogen atom, an alkyl group, an alkoxy group, a cyano group, a nitro group, a carbonyl group (an alkyloxycarbonyl group or an aryloxycarbonyl group is preferable), an aromatic group, or a heterocyclic group.

R³⁴ and R³⁵ each independently represent a hydrogen atom, an alkyl group, or an aromatic group.

R³⁷ represents a hydrogen atom, an alkyl group, an alkoxy group, a cyano group, a carbonyl group (an alkyloxycarbonyl group or an aryloxycarbonyl group is preferable), an acylamino group, or an aromatic group.

R³⁴ and R³⁵ may be bonded to each other to form a ring.

Regarding the definition and the preferred range of each of the substituents in General Formula (iii), unless otherwise specified, the descriptions regarding R¹ and R² regarding General Formula (1) described in JP2013-129712A can be applied as they are to R³¹ and R³², respectively, and the description regarding R⁴, R⁵, and R⁷ regarding General Formula (3) described in JP2013-129712A can be applied as it is to R³⁴, R³⁵, and R³⁷, respectively.

It is noted that, in the present invention, R³⁷ can adopt the following acylamino group in addition to the hydrogen atom, the alkyl group, the alkoxy group, the cyano group, the carbonyl group, and the aromatic group, which can be adopted by R⁷ regarding General Formula (3) described in JP2013-129712A.

The number of carbon atoms in the acylamino group that can be adopted as R³⁷ is preferably 1 to 12 and more preferably 1 to 6.

In the present invention, the number of carbon atoms in the alkyl group that can be adopted as R³¹, R³², and R³⁷ is more preferably 1 to 20, still more preferably 1 to 12, and particularly preferably 1 to 6.

The number of carbon atoms in the alkoxy group that can be adopted as R³¹, R³², and R³⁷ is more preferably 1 to 20, still more preferably 1 to 12, and particularly preferably 1 to 6.

The number of carbon atoms in the alkyloxycarbonyl group that can be adopted as R³¹, R³², and R³⁷ is preferably 2 to 30, more preferably 2 to 20, still more preferably 2 to 12, and particularly preferably 2 to 7.

The number of carbon atoms in the alkyl group that can be adopted as R³⁴ and R³⁵ is preferably 1 to 30, more preferably 1 to 20, and still more preferably 1 to 12. R³¹ is preferably an alkyl group or an aryl group, and more preferably an alkyl group.

R³² is preferably an alkyl group or a cyano group, and more preferably a cyano group. R³⁴ and R³⁵ are preferably a hydrogen atom or an alkyl group, and more preferably an alkyl group.

R³⁷ is preferably a hydrogen atom, an alkyl group, an acylamino group, or an aromatic group, more preferably a hydrogen atom or an alkyl group, and still more preferably an alkyl group.

Specific examples of the coloring agent represented by General Formula (iii) include the following compounds. However, the present invention is not limited thereto.

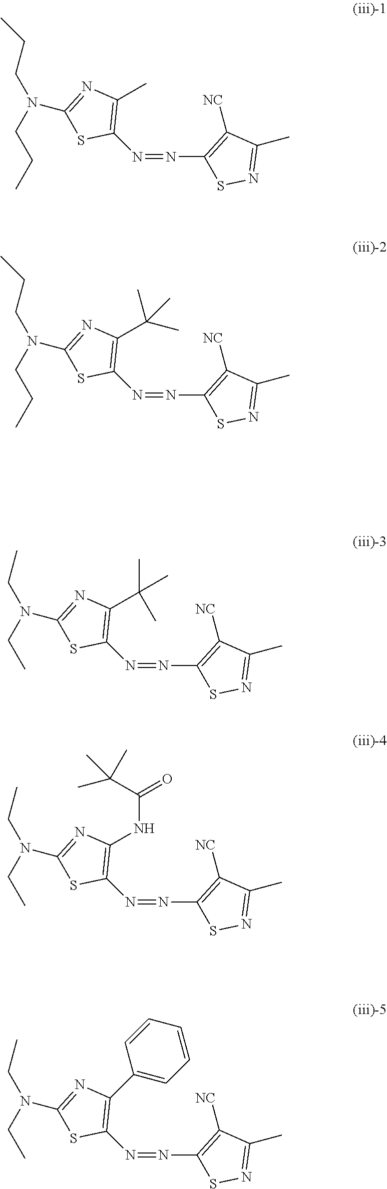

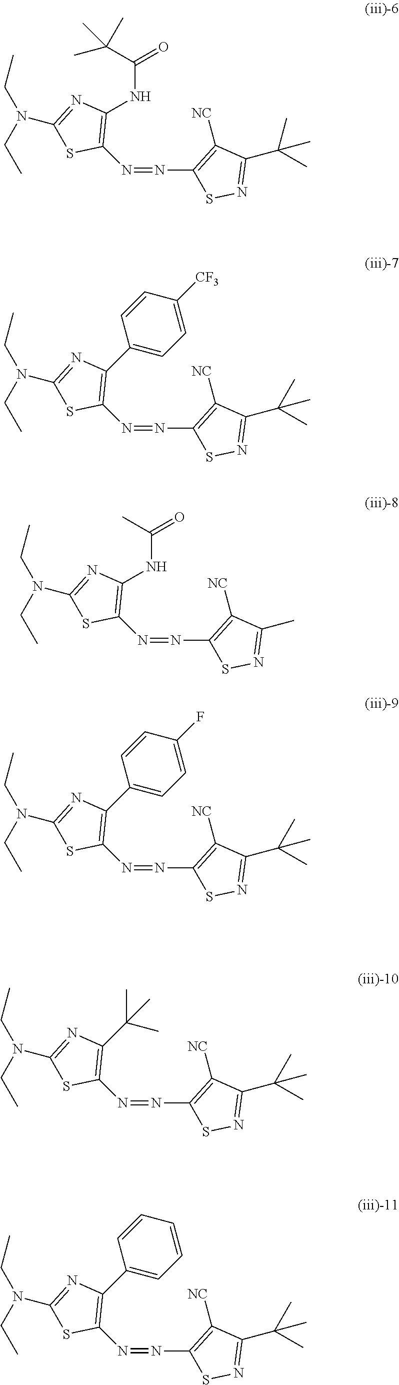

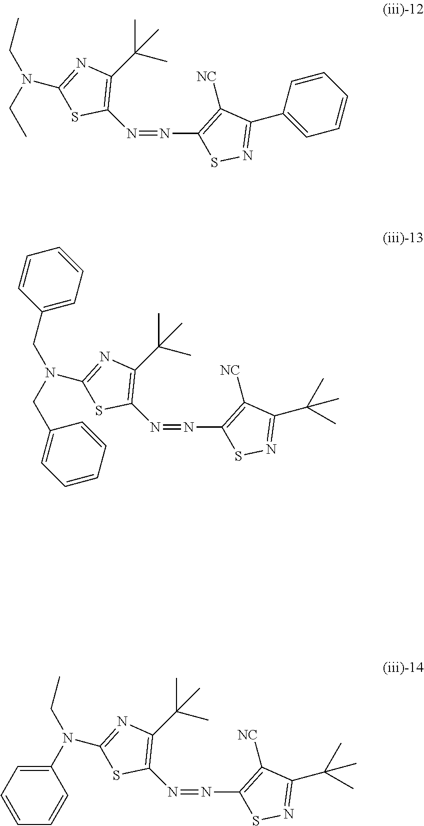

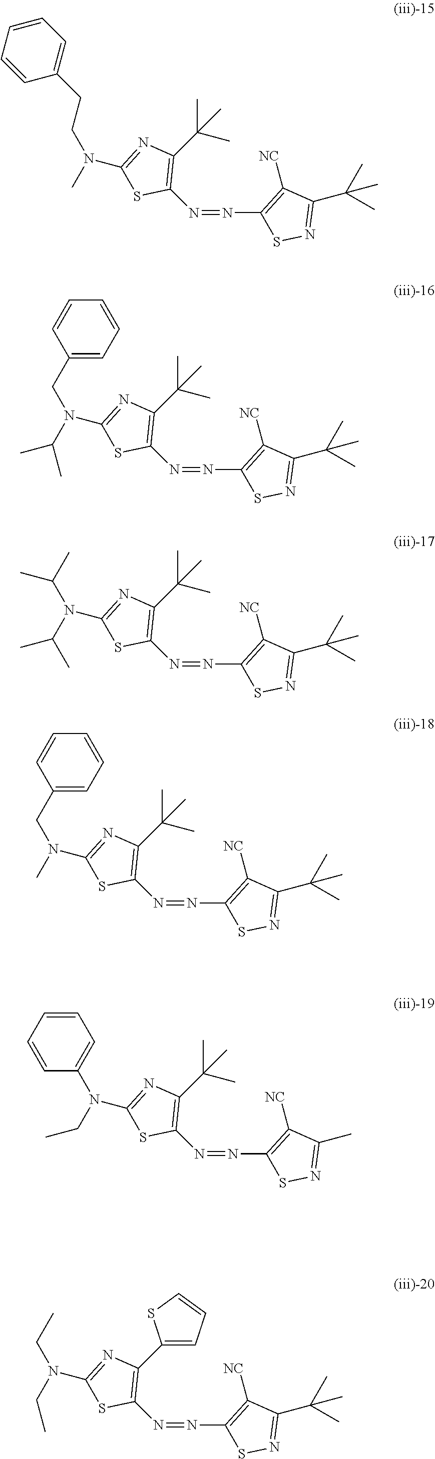

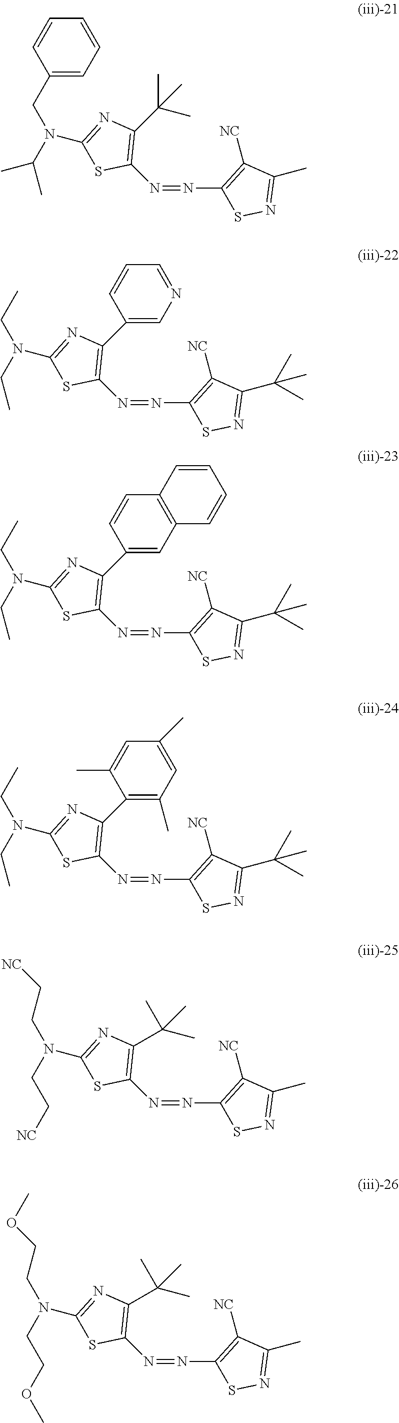

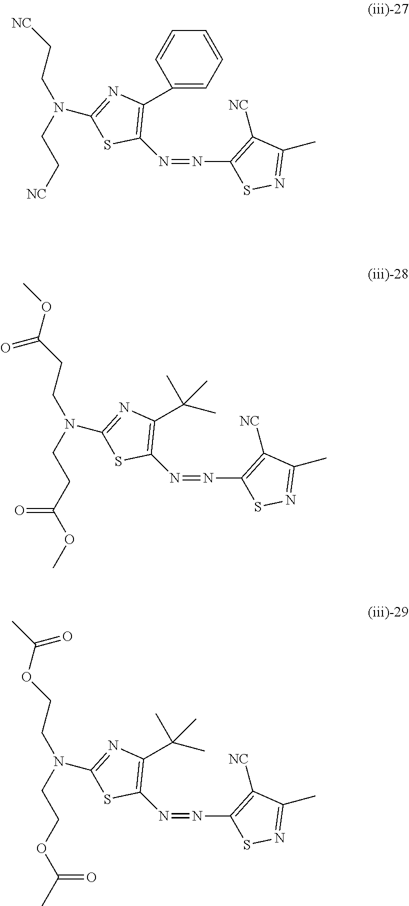

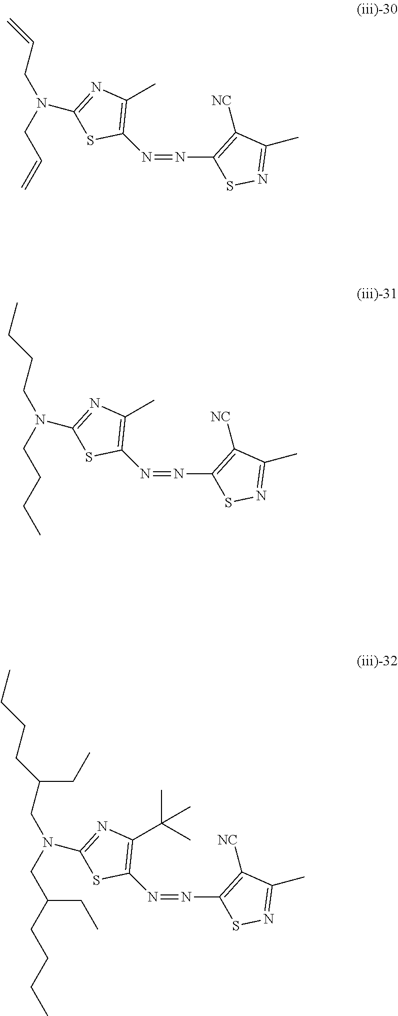

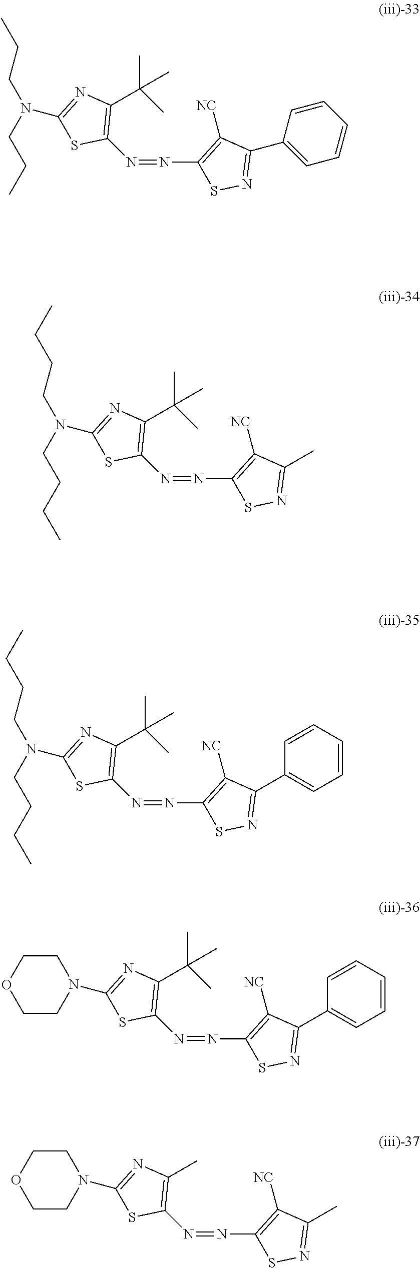

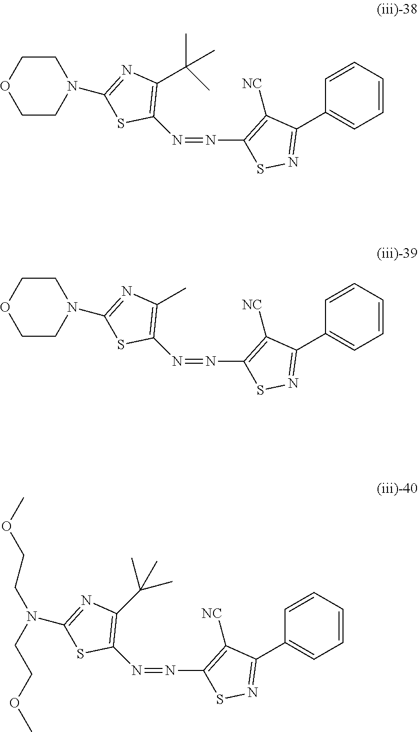

### (4) an Azo-Based Coloring Agent Represented by General Formula (iv)

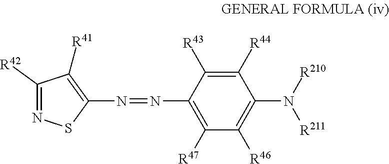

In the formula, R⁴¹ to R⁴⁴, R⁴⁶, and R⁴⁷ represent a hydrogen atom, a halogen atom, a cyano group, a nitro group, a carboxy group, a sulfo group, —OR²⁰⁸, —SR²⁰⁹, —NR²¹⁰R²¹¹, —S(═O)₂NR²¹²R²¹³, —C(═O) NR²¹⁴R²¹⁵, —NHC(═O)R²¹⁶, —C(═O)OR²¹⁷, —O(CH₂CH₂O)NR²¹⁸, —O(CH₂CH₂S)ₙR²¹⁹, —S(CH₂CH₂O)ₙR²²⁰, —S(CH₂CH₂S)ₙR²²¹, an acyclic hydrocarbon group, a monocyclic hydrocarbon group, a fused polycyclic hydrocarbon group, or a heterocyclic group.

R²⁰⁸ to R²²¹ represent a hydrogen atom, an acyclic hydrocarbon group, a monocyclic hydrocarbon group, a fused polycyclic hydrocarbon group, or a heterocyclic group. n is a positive integer.

It is noted that the acyclic hydrocarbon group, the monocyclic hydrocarbon group, the fused polycyclic hydrocarbon group, or the heterocyclic group may have, as a substituent, one or two or more of a halogen atom, a cyano group, a nitro group, a carboxy group, a sulfo group, —OR²⁰⁸, —SR²⁰⁹, —NR²¹⁰R²¹¹, —S(═O)₂NR²¹²R²¹³, —C(═O) NR²¹⁴R²¹⁵, —NHC(═O)R²¹⁶, —C(═O)OR²¹⁷, —O(CH₂CH₂O)NR²¹⁸—O(CH₂CH₂S)ₙR²¹⁹, —S(CH₂CH₂O)ₙR²²⁰, —S(CH₂CH₂S)ₙR²²¹, an acyclic hydrocarbon group, a monocyclic hydrocarbon group, a fused polycyclic hydrocarbon group, and a heterocyclic group.

The descriptions of R²¹ to R²⁴, R²⁶, R²⁷, R¹⁰⁸ to R¹²¹, and n in General Formula (ii) can be applied as they are to R⁴¹ to R⁴⁴, R⁴⁶, R⁴⁷, R²⁰⁸ to R²²¹, and n in General Formula (iv), respectively, unless otherwise specified.

R⁴³ is preferably a hydrogen atom, —OR²⁰⁸, —SR²⁰⁹, —NR²¹⁰R²¹¹, —NHC(═O)R²¹⁶, —O(CH₂CH₂O)ₙR²¹⁸, —O(CH₂CH₂S)ₙR²¹⁹, —S(CH₂CH₂O)ₙR²²⁰, —S(CH₂CH₂S)ₙR²²¹, or an acyclic hydrocarbon group (preferably an acyclic alkyl group), more preferably a hydrogen atom, —OR²⁰⁸, —SR²⁰⁹, —NR²¹⁰R²¹¹, —NHC(═O)R²¹⁶, or an acyclic alkyl group, and still more preferably —NHC(═O)R²¹⁶ or an acyclic alkyl group. Here, R²⁰⁸ to R²¹¹, R²¹⁶, and R²¹⁸ to R²²¹ are preferably an acyclic alkyl group.

In —NR²¹⁰R²¹¹ that is located at the ortho position with respect to R⁴⁴ and R⁴⁶, R²¹⁰ is preferably an acyclic alkyl group, and R²¹¹ is preferably an acyclic alkyl group and more preferably an unsubstituted acyclic alkyl group (including an acyclic alkyl group substituted with an acyclic alkyl group) or an acyclic alkyl group having-OR²⁰⁸, a monocyclic hydrocarbon group, or a fused polycyclic hydrocarbon group as a substituent. Here, R²⁰⁸ is preferably a hydrogen atom or an acyclic alkyl group.

It is noted that R⁴⁴ and/or R⁴⁶ in General Formula (iv) may be bonded to R²¹⁰ and/or R²¹¹ in-NR²¹⁰R²¹¹ located at the ortho position with respect to R⁴⁴ and R⁴⁶ on the benzene ring, thereby forming a ring. The ring which may be formed is preferably a 5- or 6-membered ring and may be saturated or unsaturated, and it is preferably a saturated 6-membered ring. The ring which may be formed may further have a substituent, and for example, it preferably has an alkyl group.

Among these, regarding a form in which a ring is formed, it is preferable that R⁴⁶ and R²¹¹ in-NR²¹⁰R²¹¹ that is located at the ortho position with respect to R⁴⁴ and R⁴⁶ on the benzene ring are bonded to each other to form a saturated 6-membered ring.

Specific examples of the coloring agent represented by General Formula (iv) include, in addition to the compounds that are used in the section of Examples described later, the compounds described in paragraph of JP2013-129712A. However, the present invention is not limited thereto.

### (5) an Indoaniline-Based Coloring Agent Represented by General Formula (v)

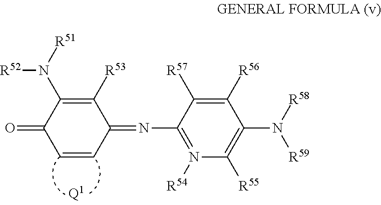

In the formula, Q¹ represents an atomic group that contains at least one nitrogen atom and is necessary for forming a 5- to 7-membered nitrogen-containing heterocyclic ring together with carbon atoms to be bonded.

R⁵¹ represents an acyl group, an alkoxycarbonyl group, an aryloxycarbonyl group, an aminocarbonyl group (carbamoyl group), or a sulfonyl group, R⁵² represents a hydrogen atom or an alkyl group, R⁵³ to R⁵⁷ represent a hydrogen atom, an alkyl group, an alkoxy group, an acylamino group, an alkylsulfonylamino group, or a halogen atom, and R⁵⁸ and R⁵⁹ represent a hydrogen atom, an alkyl group, or an aryl group.

R⁵¹ and R⁵³, R⁵⁴ and R⁵⁵, and/or R⁵⁵ and R⁵⁹, or R⁵⁸ and R⁵⁹ each may be bonded to each other to form a ring. That is, it means that R⁵¹ and R⁵³ may be bonded to each other to form a ring, R⁵⁴ and R⁵⁵ and/or R⁵⁵ and R⁵⁹ may be bonded to each other to form a ring, or R⁵⁸ and R⁵⁹ may be bonded to each other to form a ring.

Regarding the definition and the preferred range of each of the substituents in General Formula (v), unless otherwise specified, the descriptions regarding R¹ to R⁶, R⁸, R⁹, and Q¹ in General Formula (I) described in JP1990-92686A (JP-H2-92686A) can be applied as they are to R⁵¹ to R⁵⁶, R⁵⁸, R⁵⁹, and Q¹, respectively.

It is noted that in the present invention, R⁵³ to R⁵⁶ can adopt the following acylamino group and alkylsulfonylamino group, in addition to the hydrogen atom, the alkyl group, the alkoxy group, and the halogen atom, which can be adopted by R³ to R⁶ regarding General Formula (I) described in JP1990-92686A (JP-H02-92686A).

The number of carbon atoms in the acylamino group that can be adopted as R⁵³ to R⁵⁷ is preferably 1 to 12 and more preferably 1 to 6.

The number of carbon atoms in the alkylsulfonylamino group that can be adopted as R⁵³ to R⁵⁷ is preferably 1 to 12 and more preferably 1 to 6.

To the alkyl group, the alkoxy group, and the halogen atom, which can be adopted as R⁵⁷, the descriptions of the alkyl group, the alkoxy group, and the halogen atom, which can be adopted as R⁵³ to R⁵⁶, can be applied as they are.

Q¹ is preferably represented by —NR¹⁶C(═O)-Q²-. Q² represents an atomic group required for forming a 5- to 7-membered nitrogen-containing heterocyclic ring together with a carbon atom to which —NR¹⁶C(═O)-Q²- is bonded and —NR¹⁶C(═O)—, and examples thereof include a divalent amino group, an ether bond, a thioether bond, an alkylene bond, an ethylene bond, an imino bond, a sulfonyl bond, a carbonyl bond, an arylene bond or a divalent heterocyclic group, and a group obtained by combining a plurality of these. R¹⁶ represents a hydrogen atom, an alkyl group, an aryl group, or a heterocyclic group, where a hydrogen atom is preferable. To each of the definition and the preferred range of each substituent of R¹⁶, the description regarding R¹⁶ regarding General Formula (I) described in JP1990-92686A (JP-H2-92686A) can be applied as it is.

R⁵¹ is preferably an acyl group having 2 to 7 carbon atoms or an alkoxycarbonyl group having 2 to 7 carbon atoms.

R$2 is preferably a hydrogen atom, and R⁵³ to R⁵⁶ are preferably a hydrogen atom. R⁵⁷ is preferably an alkoxy group, an acylamino group, or an alkylsulfonylamino group, and more preferably an alkoxy group or an acylamino group.

R⁵⁸ and R⁵⁹ are preferably an alkyl group having 1 to 6 carbon atoms.

Among the above, the indoaniline-based coloring agent represented by General Formula (v) is preferably represented by General Formula (v-a).

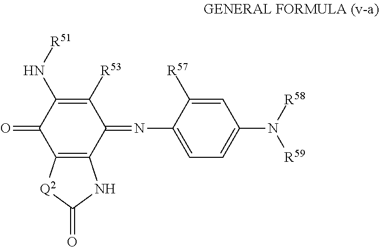

In the formula, R⁵¹, R⁵³, R⁵⁷ to R⁵⁹, and Q² have the same meanings as R⁵¹, R⁵³, R⁵⁷ to R⁵⁹, and Q² in General Formula (v).

Q² is preferably —CR¹¹R¹²CR¹³R¹⁴—, —CR¹¹R¹²—, or —NR¹¹—, and more preferably —CR¹¹R¹²CR¹³R¹⁴—.

R¹¹ to R¹⁴ represent a hydrogen atom or an alkyl group having 1 to 4 carbon atoms, and it is preferable that R¹¹ and R¹² are a hydrogen atom and R¹³ and R¹⁴ are an alkyl group having 1 to 4 carbon atoms

It is noted that —CR¹¹R¹²CR¹³R¹⁴— is preferably bonded to >C═O on the side of the carbon atom to which R¹¹ and R¹² are bonded.

Specific examples of the coloring agent represented by General Formula (v) include, in addition to the compounds that are used in the section of Examples described later, the compounds of Nos. 1 to 51 on pages 5 and 6 of JP1990-92686A (JP-H2-92686A). However, the present invention is not limited thereto.

The total content of the dyes in the wavelength selective absorption layer is preferably 0.10% by mass or more, more preferably 0.15% by mass or more, still more preferably 0.20% by mass or more, particularly preferably 0.25% by mass or more, and especially preferably 0.30% by mass or more. In a case where the total content of the dyes in the wavelength selective absorption layer is equal to or higher than the above-described preferred lower limit value, a good antireflection effect can be obtained.

In addition, the total content of the dye in the wavelength selective absorption layer is usually 50% by mass or less, preferably 40% by mass or less, more preferably 30% by mass or less, still more preferably 15% by mass or less, and particularly preferably 10% by mass or less.

That is, the total content of the dye in the wavelength selective absorption layer is preferably 0.10% to 50% by mass, more preferably 0.15% to 40% by mass, still more preferably 0.20% to 30% by mass, particularly preferably 0.25% to 15% by mass, and especially preferably 0.30% to 10% by mass.

The content of the azo-based coloring agent represented by General Formula (i) in the wavelength selective absorption layer is preferably 0.01% to 30% by mass and more preferably 0.1% to 10% by mass. In the wavelength selective absorption layer, the content of each of the coloring agents of the azo-based coloring agent represented by General Formula (ii), the azo-based coloring agent represented by General Formula (iii), the azo-based coloring agent represented by General Formula (iv), and the indoaniline-based coloring agent represented by General Formula (v) is also preferably 0.01% to 30% by mass and more preferably 0.1% to 10% by mass. Similarly to the content of the azo-based coloring agent represented by General Formula (i). In the wavelength selective absorption layer, all of the dyes may be composed of at least one of the azo-based coloring agent represented by any of General Formulae (i) to (iv) or the indoaniline-based coloring agent represented by General Formula (v).

### <Resin>

In the light absorption filter according to the embodiment of the present invention, the resin contained in the wavelength selective absorption layer described above (hereinafter, also referred to as a “matrix resin”) is not particularly limited as long as it can disperse (preferably dissolve) the dye described above and has the desired light transmittance (the light transmittance is preferably 80% or more in the visible range in a wavelength of 400 to 800 nm).

In the light absorption filter according to the embodiment of the present invention, the resin contained in the wavelength selective absorption layer may be a resin A having an acid group described later, or may contain other resins in addition to the resin A having an acid group described later.

In the light absorption filter I according to the embodiment of the present invention, the resin contained in the wavelength selective absorption layer is not particularly limited as long as it can exhibit the decolorization action of the dye by the radical generated from the compound B that forms a hydrogen bond with the acid group contained in the resin A and generates a radical upon ultraviolet irradiation, in addition to the above-described effect.

As a polymer that constitutes the above-described resin, various polymers can be used. From the viewpoint that the molecular weight of the resin is not easily reduced upon ultraviolet irradiation, a polymer having an aromatic ring or an alicyclic structure in the side chain is preferable, and a (meth)acrylic polymer containing a constitutional unit having an aromatic ring or an alicyclic structure is more preferable. Among the above, from the viewpoint of further improving the decolorization rate and further improving the heat resistance and the light resistance as well, a (meth)acrylic polymer containing a constitutional unit having an alicyclic structure in the side chain is still more preferable.

Here, the (meth)acrylic polymer refers to a polymer containing at least one of a constitutional unit derived from (meth)acrylic acid or a constitutional unit derived from (meth)acrylic acid ester. In a case where the polymer includes a constitutional unit derived from (meth)acrylic acid, the constitutional unit derived from (meth)acrylic acid is a constitutional unit having a carboxy group as an acid group included in the resin A described later, and corresponds to a carboxy group-containing polymer constituting the resin A described later.

In addition, in the present disclosure, the “main chain” represents a relatively longest bonding chain in a molecule of a high-molecular-weight compound, and the “side chain” represents an atomic group branched from the main chain.

Examples of the monomer from which a constitutional unit having an aromatic ring is derived include benzyl acrylate, benzyl methacrylate, naphthyl acrylate, naphthyl methacrylate, naphthyl methyl acrylate, and naphthyl methyl methacrylate. The content of the constitutional unit having an aromatic ring is preferably 5% to 100% by mass, more preferably 10% to 100% by mass, and still more preferably 20% to 100% by mass, with respect to the total mass of the polymer.

Examples of the monomer from which a constitutional unit having an alicyclic structure is derived include dicyclopentanyl (meth)acrylate, cyclohexyl (meth)acrylate, and isobornyl (meth)acrylate.

In a case where the polymer contains a constitutional unit having an alicyclic structure, the content of the constitutional unit having an alicyclic structure is preferably 1% to 90% by mass, more preferably 5% to 90% by mass, and still more preferably 5% to 80% by mass, with respect to the total mass of the polymer.

From the viewpoint of adjusting the glass transition temperature and the like, the polymer that constitutes the resin may contain a constitutional unit that has an alkyl group having 1 to 14 carbon atoms. Examples of the constitutional unit having an alkyl group having 1 to 14 carbon atoms include a constitutional unit derived from an alkyl (meth)acrylate, such as methyl(meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylhexyl (meth)acrylate, 2-ethylbutyl (meth)acrylate, n-octyl (meth)acrylate, isooctyl (meth)acrylate, isononyl (meth)acrylate, lauryl (meth)acrylate, or tetradecyl (meth)acrylate. In the present invention, one kind of the constitutional unit having an alkyl group having 1 to 14 carbon atoms may be used alone, or two or more kinds thereof may be used in combination. The content of the constitutional unit having an alkyl group having 1 to 14 carbon atoms is preferably 0% by mass to 95% by mass with respect to the total mass of the polymer that constitutes the resin.

The weight-average molecular weight (Mw) of the polymer that constitutes the resin is preferably 10,000 or more, more preferably 10,000 to 200,000, and still more preferably 15,000 to 150,000.

In addition, as another example of the above-described embodiment of the resin, the description of the matrix resin described in to of WO2021/132674A can be applied.

### <Resin a Containing Acid Group>

In the light absorption filter according to the embodiment of the present invention, the wavelength selective absorption layer contains a resin A having an acid group (in the present invention, also simply referred to as a “resin A”).

The acid group contained in the resin A is preferably a proton dissociable group having a pKa of 12 or less. Specific examples of the acid group include a carboxy group, a sulfonamide group (—S(═O)₂NH₂), a phosphonate group (—P(═O)(OH)₂), a phosphate group (—OP(═O)(OH)₂), a sulfo group, a phenolic hydroxyl group, and a sulfonyl imide group, where a carboxy group is preferable. It is noted that pKa means a negative common logarithm (−log Ka) of the acid dissociation constant (Ka) in water at 25° C., and it can be calculated in the same manner, except that in a calculation of the pKa of the compound B described later, a mixed solvent of water/methanol=50/50 (in terms of volume ratio) is changed to water.

In the present invention, the resin A containing an acid group means that a polymer constituting the resin A contains an acid group.

The lower limit value of the weight-average molecular weight of the polymer constituting the resin A is 5,000 or more, and from the viewpoint of physical properties of the optical filter, it is preferably 10,000 or more and more preferably 15,000 or more. The upper limit value thereof is not particularly limited; however, it is preferably 500,000 or less, more preferably 200,000 or less, and still more preferably 150,000 or less from the viewpoint of solubility in a solvent. That is, 5,000 to 500,000 is practical, 10,000 to 200,000 is preferable, and 15,000 to 150,000 is more preferable.

In the present invention, the weight-average molecular weight of the polymer can be measured as a molecular weight in terms of polystyrene by gel permeation chromatography (GPC).

Specifically, a GPC device HLC-8220 (product name, manufactured by Tosoh Corporation) is used, tetrahydrofuran is used as an eluent, G3000HXL+G2000HXL (both are product names, manufactured by Tosoh Corporation) are used as columns, and detection can be performed by a differential refractive index (RI) at 23° C. and a flow rate of 1 mL/min.

In addition, a part or all of the acid groups contained in the resin A may or may not be anionized in the light absorption filter, and in the present invention, both an anionized acid group and a non-anionized acid group are also referred to as an acid group. That is, the resin A may or may not be anionic in the light absorption filter.

As the polymer constituting the resin A, from the viewpoint of excellent film-forming properties of the light absorption filter, a polymer having a carboxy group, that is, a carboxy group-containing polymer is preferable.

It is noted that a part or all of the carboxy groups (—COOH) contained in the carboxy group-containing polymer may or may not be anionized in the light absorption filter, and both an anionized carboxy group (—COO—) and a non-anionized carboxy group are also referred to as a carboxy group.

That is, the carboxy group-containing polymer may or may not be anionized in the light absorption filter, and both an anionized carboxy group-containing polymer and a non-anionized carboxy group-containing polymer are also referred to as a polymer.

In the light absorption filter according to the embodiment of the present invention, the content of the resin A in the wavelength selective absorption layer is preferably 50% by mass or more and less than 100% by mass, more preferably 60% by mass or more and less than 100% by mass, and still more preferably 65% by mass or more and less than 100% by mass. The upper limit value thereof is also preferably 99% by mass or less, more preferably 97% by mass or less, still more preferably 95% by mass or less, and particularly preferably 90% by mass or less.

The resin A may be used alone or in combination of two or more kinds thereof.

### (Carboxy Group-Containing Polymer)

The carboxy group-containing polymer may further have, as an acid group, an acid group other than the carboxy group. Examples of the acid group other than the carboxy group include a phenolic hydroxyl group, a phosphate group, and a sulfonate group.

In a case where the carboxy group-containing polymer is a copolymer, the structure of the polymer may be a random polymer or a regular polymer such as a block.

### <<Constitutional Unit Having Carboxy Group>>

The carboxy group-containing polymer preferably has a constitutional unit having a carboxy group.

Examples of the constitutional unit having a carboxy group include a constitutional unit derived from (meth)acrylic acid, crotonic acid, itaconic acid, maleic acid, or fumaric acid. Among the above, a constitutional unit derived from (meth)acrylic acid is preferable from the viewpoint of excellent decolorization properties of the dye.

In the carboxy group-containing polymer, in a case where the total of all the constitutional units of the carboxy group-containing polymer is set to 100 mol %, the content of the constitutional unit having a carboxy group is preferably 1 to 100 mol %, more preferably 10 to 90 mol %, still more preferably 30 to 90 mol %, particularly preferably 45 to 80 mol %, and especially preferably 45 to 75 mol %.

One kind of the constitutional unit having a carboxy group may be used alone, or two or more kinds thereof may be used in combination.

### <<Constitutional Unit Having Aromatic Ring>>

It is also preferable that the carboxy group-containing polymer has a constitutional unit having an aromatic ring (preferably, an aromatic hydrocarbon ring) in addition to the above-described constitutional unit. Examples thereof include a constitutional unit derived from a (meth)acrylate having an aromatic ring (specifically, benzyl (meth)acrylate, phenethyl (meth)acrylate, phenoxyethyl (meth)acrylate, or the like).

In the carboxy group-containing polymer, the content of the constitutional unit having an aromatic ring is preferably 0% to 97% by mole, more preferably 0% to 95% by mole, and still more preferably 0% to 90% by mole in a case where the total of all the constitutional units of the carboxy group-containing polymer is set to 100% by mole.

One kind of the constitutional unit having an aromatic ring may be used alone, or two or more kinds thereof may be used in combination.

### <<Constitutional Unit Having Alicyclic Structure>>

It is also preferable that the carboxy group-containing polymer has a constitutional unit having an alicyclic structure in addition to the above-described constitutional unit.

Examples of the alicyclic structure include a tricyclo[5.2.1.02.6]decane ring structure (also referred to as tetrahydrodicyclopentadiene; a monovalent group is dicyclopentanyl), a tricyclo[5.2.1.02.6]decane-3-ene ring structure (also referred to as 5,6-dihydrodicyclopentadiene; a monovalent group is dicyclopentenyl), an isobornane ring structure (a monovalent group is isobornyl), an adamantane ring structure (a monovalent group is adamantyl), and a cyclohexane ring structure (a monovalent group is cyclohexyl).

Examples of the constitutional unit having an alicyclic structure include a constitutional unit derived from a (meth)acrylate having an alicyclic structure. Specific examples thereof include a constitutional unit derived from dicyclopentanyl (meth)acrylate, dicyclopentenyl (meth)acrylate, isobornyl (meth)acrylate, adamantyl (meth)acrylate, cyclohexyl (meth)acrylate, or the like.

In the carboxy group-containing polymer, in a case where the total of all the constitutional units of the carboxy group-containing polymer is set to 100% by mole, the content of the constitutional unit having an alicyclic structure is preferably 0% to 99% by mole, more preferably 10% to 90% by mole, still more preferably 10% to 70% by mole, particularly preferably 20% to 55% by mole, and especially preferably 25% to 55% by mole.

One kind of the constitutional unit having an alicyclic structure may be used alone, or two or more kinds thereof may be used in combination.

### <<Another Constitutional Unit>>

The carboxy group-containing polymer may have another constitutional unit in addition to the above-described constitutional units.

Examples of the other constitutional unit include a constitutional unit derived from methyl(meth)acrylate.

In the carboxy group-containing polymer, the content of the other constitutional unit is preferably 0% to 70% by mole, more preferably 0% to 50% by mole, and still more preferably 0% to 20% by mole in a case where the total of all the constitutional units of the carboxy group-containing polymer is set to 100% by mole.

One kind of the other constitutional unit may be used alone, or two or more kinds thereof may be used in combination.

### <Compound B>

In the light absorption filter I according to the embodiment of the present invention, the wavelength selective absorption layer contains a compound B (in the present invention, also simply referred to as a “compound B”) that forms a hydrogen bond with the acid group contained in the resin A and generates a radical upon ultraviolet irradiation.

The compound B is preferably a compound having such a structure that absorbs ultraviolet rays to be in an excited state, thereby having an increased basicity. In a case where the basicity of the compound B is increased in the excited state, it is possible to form a complex in which the acid group contained in the resin A interacts more strongly with the compound B, and it is possible to increase the efficiency of generating radicals.

A structure contained in the compound B, the structure that is capable of forming a hydrogen bond with the acid group contained in the resin A, may be a whole structure of the compound B or may be a partial structure that constitutes a part of the compound B.

The compound B may be a high-molecular-weight compound (which means a compound having a molecular weight of 5,000 or more) or a low-molecular-weight compound (which means a compound having a molecular weight of less than 5,000), and it is preferably a low-molecular-weight compound.

The molecular weight of the compound B as a low-molecular-weight compound is less than 5,000, and it is preferably less than 1,000, more preferably 300 or less, and still more preferably 250 or less. The lower limit value thereof is not particularly limited; however, it is preferably 65 or more and more preferably 75 or more. Examples of the preferred range of the molecular weight of the compound B which is a low-molecular-weight compound include 65 to 300 and more preferably 75 to 250.

From the viewpoint that the molar absorption coefficient with respect to ultraviolet rays is large, the compound B is preferably an aromatic compound.

Here, the aromatic compound is a compound having one or more aromatic rings.

Only one aromatic ring may be present in the compound B, or a plurality of aromatic rings may be present therein. In a case where a plurality of aromatic rings is present, the aromatic rings may be present, for example, in the side chain or the like of the polymer that constitutes the resin.

The above-described aromatic ring may be any of an aromatic hydrocarbon ring or an aromatic heterocyclic ring, and it is preferable that the compound B has at least an aromatic heterocyclic ring. In a case of an aromatic heterocyclic ring (also referred to as a heteroaromatic ring), the compound B is a compound having one or more (for example, 1 to 4) heteroatoms (at least one of a nitrogen atom, an oxygen atom, a sulfur atom, or the like) as ring member atoms (ring-constituting atoms), and is preferably a compound having one or more (for example, 1 to 4) nitrogen atoms as ring member atoms.

Since the unsubstituted aromatic hydrocarbon ring does not have a function of forming a hydrogen bond with the acid group contained in the resin A and generating a radical upon ultraviolet irradiation, the unsubstituted aromatic hydrocarbon ring does not correspond to the compound B. In addition, an unsubstituted aromatic hydrocarbon ring in a form in which the unsubstituted aromatic hydrocarbon ring is bonded to the side chain of the polymer that constitutes the resin does not have a function of forming a hydrogen bond with the acid group contained in the resin A and generating a radical upon ultraviolet irradiation, and thus it does not correspond to the compound B.

The number of ring member atoms in the above-described aromatic ring is preferably 5 to 15.

Examples of the above-described aromatic ring include monocyclic aromatic rings such as a pyridine ring, a pyrazine ring, a pyrimidine ring, and a triazine ring; aromatic rings in which two rings are fused, such as a quinoline ring, an isoquinoline ring, a quinoxaline ring, and a quinazoline ring; and aromatic rings in which three rings are fused, such as an acridine ring, a phenanthridine ring, a phenanthroline ring, and a phenazine ring.

The above-described aromatic ring may have one or more (for example, 1 to 5) substituents, and examples of the substituent include an alkyl group, an aryl group, a halogen atom, an acyl group, an alkoxycarbonyl group, an arylcarbonyl group, a carbamoyl group, a hydroxy group, a cyano group, and a nitro group. In addition, in a case where the above-described aromatic ring has two or more substituents, a plurality of substituents may be bonded to each other to form a non-aromatic ring.

In a case where a plurality of aromatic rings (for example, 2 to 5 aromatic rings) forms a series of aromatic ring structures bonded with a structure selected from a single bond, a carbonyl bond, and a multiple bond (for example, a vinylene group which may have a substituent, —C═C—, —N═N—, and the like), the entire series of aromatic ring structures is regarded as one specific structure.

A series of aromatic ring structures in which the plurality of aromatic rings are bonded through a structure selected from a single bond, a carbonyl bond, or a multiple bond do not correspond to the above-described unsubstituted aromatic hydrocarbon ring, and do not correspond to the unsubstituted aromatic hydrocarbon ring in a form in which the unsubstituted aromatic hydrocarbon ring is bonded to a side chain of the polymer constituting the resin.

In addition, it is preferable that one or more of the aromatic rings constituting the series of aromatic ring structures are the above-described heteroaromatic rings.

Specific examples of the compound B include monocyclic aromatic compound such as a pyridine compound (pyridine or a pyridine derivative), a pyrazine compound (pyrazine or a pyrazine derivative), a pyrimidine compound (pyrimidine or a pyrimidine derivative), and a triazine compound (triazine or a triazine derivative); compounds in which two rings are fused to form an aromatic ring, such as a quinoline compound (quinoline or a quinoline derivative), an isoquinoline compound (isoquinoline or an isoquinoline derivative), a quinoxaline compound (quinoxaline or a quinoxaline derivative), and a quinazoline compound (quinazoline or a quinazoline derivative); and compounds in which three or more rings are fused to form an aromatic ring, such as an acridine compound (acridine or an acridine derivative), a phenanthridine compound (phenanthridine or a phenanthridine derivative), a phenanthroline compounds (phenanthroline or a phenanthroline derivative), and a phenazine compounds (phenazine or a phenazine derivative). In the specific examples of the compound B, the compound is used to have a meaning including not only the compound itself but a compound having a substituent (referred to as a “derivative”), including an unsubstituted compound in which a part of the structure has been changed, within a range where the effect of the present invention is not impaired.

It is presumed that this compound B forms a complex with the resin A and generates two molecules of radicals by the following mechanism upon ultraviolet irradiation.
1) The compound B in an excited state is generated by absorbing ultraviolet rays.
2) The hole moves from the excited state compound B to the ground state resin A (the electron of the resin A moves to the orbital on the low energy side of the two half-occupied orbitals of the excited state compound B).
3) A radical in which a hydrogen radical is added to the compound B and a radical in which a hydrogen radical is eliminated from the resin A are generated by the migration of a proton from the resin A to the compound B.

In a case where the resin A is a compound having a carboxy group, the following reaction further occurs, and a radical is generated by a photodecarboxylation reaction.
4) Carbon dioxide is eliminated from a radical obtained by eliminating a hydrogen radical from the resin A.

Among the above, the compound B is preferably one or more among quinoline compounds (quinoline and a quinoline derivative) and isoquinoline compounds (isoquinoline and an isoquinoline derivative).

The substituent which may be contained in these compounds is preferably an alkyl group, an aryl group, a halogen atom, an acyl group, an alkoxycarbonyl group, an arylcarbonyl group, a carbamoyl group, a hydroxy group, a cyano group, or a nitro group.

In a case where the compound B is a polymer, the compound B may be a polymer in which the above-described specific structure is bonded to a polymer main chain through a single bond or a linking group.

The compound B as a polymer is obtained by, for example, polymerizing a monomer having a heteroaromatic ring (specifically, a (meth)acrylate monomer having a heteroaromatic ring having a vinyl group and/or a specific structure (preferably, a heteroaromatic ring)). As necessary, copolymerization with another monomer may be carried out.

Specific examples of the compound B include quinoline, 2-methylquinoline, 4-methylquinoline, 2,4-dimethylquinoline, 2-methyl-4-phenylquinoline, isoquinoline, 1-methylisoquinoline, 3-methylisoquinoline, and 1-phenylisoquinoline.

From the viewpoint of achieving both the decolorization property of the ultraviolet irradiated portion and the durability of the dye in the ultraviolet non-irradiated portion, the content of the compound B is preferably 0.1% to 50% by mass, more preferably 2.0% to 40% by mass, still more preferably 4% to 35% by mass, and particularly preferably 8% to 30% by mass, with respect to the total mass of the wavelength selective absorption layer in the light absorption filter I according to the embodiment of the present invention.

In addition, the pKaH (pKa of a conjugate acid) as a measure of basicity of the compound B can be, for example, 2.0 to 13.0, and from the viewpoint of achieving both the decolorization property of the ultraviolet irradiated portion and the durability of the dye in the ultraviolet non-irradiated portion, it is preferably 2.0 to 7.0, more preferably 3.0 to 6.0, and still more preferably 4.3 to 5.5.

In the present invention, the pKa means a negative common logarithm (−log Ka) of the acid dissociation constant (Ka) in a mixed solvent of water/methanol=50/50 (in terms of volume ratio) at 25° C. The pKa can be calculated by dropwise adding a 0.01 mol/L sodium hydroxide aqueous solution to a mixed solution of water/methanol=50/50 (in terms of volume ratio) of a measurement sample (a conjugate acid of the compound B) and reading the amount of the sodium hydroxide aqueous solution that has been dropwise added up to the half-equivalent point.

One kind of the compound B may be used alone, or two or more kinds thereof may be used in combination.

### <Another Component>

The wavelength selective absorption layer in the light absorption filter according to the embodiment of the present invention may contain the above-described resin A containing a dye acid group, a compound B that forms a hydrogen bond with the acid group contained in the above-described resin A and generates a radical upon ultraviolet irradiation, a resin other than the above-described resin A, a photoradical generator, and the like, and may further contain an antifading agent, a leveling agent (surfactant), and the like.

In the present invention, the photoradical generator means a compound other than the above-described compound B, which generates a radical upon ultraviolet irradiation. Regarding specific examples, preferred forms, commercially available products, contents, and the like of the photoradical generator, the description of the specific examples, preferred forms, commercially available products, contents, and the like of the photoradical generator in paragraphs to of WO2023/068235A can also be suitably used in the present invention. In the description of the content of the photoradical generator in paragraph of WO2023/068235A, “the light absorption filter according to the embodiment of the present invention” and “the radical generator (preferably the photoradical generator)” are each replaced with “the wavelength selective absorption layer in the light absorption filter according to the embodiment of the present invention” and “the photoradical generator”.

In addition, it is preferable that the antifading agent does not inhibit the decolorization due to ultraviolet irradiation but has an effect of suppressing the dye decomposition due to visible light. As the antifading agent used in the present invention, the antifading agents described in paragraphs to of WO2022/210444A can be used.

### (Leveling Agent)

A leveling agent (a surfactant) can be appropriately mixed into the wavelength selective absorption layer in the light absorption filter according to the embodiment of the present invention. As the leveling agent, a commonly used compound can be used, and a fluorine-containing surfactant is particularly preferable. Specific examples thereof include the compounds described in paragraphs to of JP2001-330725A. In addition, as the commercially available product, MEGAFACE F (product name) series manufactured by DIC Corporation can also be used.

The content of the leveling agent in the wavelength selective absorption layer in the light absorption filter according to the embodiment of the present invention is appropriately adjusted according to the intended purpose.

The wavelength selective absorption layer in the light absorption filter according to the embodiment of the present invention may contain a low-molecular-weight plasticizer, an oligomer-based plasticizer, a retardation modifier, a deterioration inhibitor, an infrared absorber, an antioxidant, a filler, a compatibilizer, and the like, in addition to the above-described respective components.

In addition, the wavelength selective absorption layer in the light absorption filter according to the embodiment of the present invention may contain a reaction accelerator or a reaction retarder described in paragraphs and of JP1997-286979A (JP-H09-286979A).

### <<Manufacturing Method for Wavelength Selective Absorption Layer>>

The wavelength selective absorption layer in the light absorption filter according to the embodiment of the present invention can be produced according to conventional method by a solution film-forming method, a melt extrusion method, or a method (coating method) of forming a coating layer on a base material film (support film) by any method, and stretching can also be appropriately combined. The wavelength selective absorption layer in the light absorption filter according to the embodiment of the present invention is preferably produced by a coating method.

For the solution film-forming method and melt extrusion method described above, the descriptions regarding the solution film-forming method and the melt extrusion method in to of WO2021/132674A can be applied as they are.

### (Coating Method)

In the coating method, a solution of a material of the wavelength selective absorption layer is applied onto a support film to form a coating layer. A mold release agent or the like may be appropriately applied onto the surface of the support film in advance in order to control the adhesiveness to the coating layer. The coating layer can be used by peeling off the support film after laminating the coating layer with other members through an adhesive layer in a subsequent step or after laminating a gas barrier layer or the like without using an adhesive layer in a subsequent step. Any adhesive can be appropriately used as the adhesive constituting the adhesive layer. The whole support film can be appropriately stretched in a state where a solution of a material of the wavelength selective absorption layer is applied onto the support film or in a state where a coating layer is laminated on the support film.

The solvent used for the solution of the material of the wavelength selective absorption layer can be appropriately selected from the viewpoint that the material of the wavelength selective absorption layer can be dissolved or dispersed, a uniform surface shape can be easily achieved during the coating step and drying step, liquid preservability can be secured, an appropriate saturated vapor pressure is provided.

### —Addition of Coloring Agent (Dye) and the Like—

The timing of adding the dye to the material of the wavelength selective absorption layer is not particularly limited as long as the dye and the antifading agent are added at the time of film formation. For example, the above-described resin A may be added at the time of synthesizing the resin A, or may be mixed with the material of the wavelength selective absorption layer at the time of preparing a coating liquid for the material of the wavelength selective absorption layer. In addition, the same applies in a case where the wavelength selective absorption layer contains the above-described compound B or the like.

### —Support Film—

The support film to be used for forming the wavelength selective absorption layer according to the embodiment of the present invention by a coating method or the like preferably has a film thickness of 5 to 100 μm, more preferably 10 to 75 μm, and still more preferably 15 to 55 μm. In a case where the film thickness is equal to or larger than the above-described preferred lower limit value, sufficient mechanical strength can be easily secured, and failures such as curling, wrinkling, and buckling are less likely to occur. In addition, in a case where the film thickness is equal to or smaller than the preferred upper limit value, the surface pressure applied to the multilayer film is easily adjusted to be in an appropriate range, and thus adhesion defect is less likely to occur in a case where a multilayer film of the adjacent layer, the wavelength selective absorption layer, and the support film is stored, for example, in a form of a long roll.

The surface energy of the support film is not particularly limited, and by adjusting the relationship between the surface energy of the material of the wavelength selective absorption layer or the coating solution and the surface energy of the surface of the support film on which the wavelength selective absorption layer is to be formed, the adhesive force between the wavelength selective absorption layer and the support film can be adjusted. In a case where the surface energy difference is reduced, the adhesive force tends to increase, and in a case where the surface energy difference is increased, the adhesive force tends to decrease, and thus the surface energy can be set appropriately.

In addition, the surface unevenness of the support film is not particularly limited; however, depending on the relationship between the surface energy of the wavelength selective absorption layer surface, the hardness, and the surface unevenness, and the surface energy and hardness of the support film opposite to the side on which the wavelength selective absorption layer is formed, the surface unevenness of the support film can be adjusted in order to prevent adhesion defect in a case where a multilayer film of the adjacent layer, the wavelength selective absorption layer, and the support film is stored, for example, in a form of a long roll. In a case where the surface unevenness is increased, adhesion defect tends to be suppressed, and in a case where the surface unevenness is reduced, the surface unevenness of the wavelength selective absorption layer tends to decrease and the haze of the wavelength selective absorption layer tends to be small. Thus, the surface unevenness can be set appropriately.

For such a support film, any material and film can be appropriately used. Specific examples of the material include a polyester-based polymer (including a polyethylene terephthalate-based polymer), an olefin-based polymer, a cycloolefin-based polymer, a (meth)acrylic polymer, a cellulose-based polymer, and a polyamide-based polymer. In addition, a surface treatment can be appropriately carried out for the intended purpose of adjusting the surface properties of the support film. For example, a corona treatment, a room temperature plasma treatment, or a saponification treatment can be carried out to decrease the surface energy, and a silicone treatment, a fluorine treatment, an olefin treatment, or the like can be carried out to raise the surface energy.

### <Film Thickness of Wavelength Selective Absorption Layer>

The film thickness of the wavelength selective absorption layer is not particularly limited; however, it is preferably 1 to 18 μm, more preferably 1 to 12 μm, still more preferably 1 to 8 μm, and particularly preferably 1 to 5 μm. In a case where the film thickness is equal to or smaller than the above-described preferred upper limit value, the decrease in the degree of polarization due to the fluorescence emitted by a dye can be suppressed by adding the dye to the thin film at a high concentration. In addition, the effect of the quencher is likely to be exhibited. On the other hand, in a case where the film thickness is equal to or larger than the above-described preferred lower limit value, it is easy to maintain the evenness of the in-plane absorbance.

In the present invention, the film thickness of 1 to 18 μm means that the thickness of the wavelength selective absorption layer is within a range of 1 to 18 μm in a case of being measured at any portion. The same applies to the film thicknesses of 1 to 12 μm, 1 to 8 μm, and 1 to 5 μm. The film thickness can be measured with an electronic micrometer manufactured by Anritsu Corporation.

### <Treatment of Wavelength Selective Absorption Layer>

The wavelength selective absorption layer may be subjected to a hydrophilic treatment by any of glow discharge treatment, corona discharge treatment, or alkali saponification treatment, and a corona discharge treatment is preferably used. It is also preferable to apply the method disclosed in JP1994-94915A (JP-H6-94915A) and JP1994-118232A (JP-H6-118232A).

As necessary, the obtained film may be subjected to a heat treatment step, a superheated steam contact step, an organic solvent contact step, or the like. In addition, a surface treatment may be appropriately carried out.

In addition, as a pressure-sensitive adhesive layer, a layer consisting of a pressure-sensitive adhesive composition in which a (meth)acrylic resin, a styrene-based resin, a silicone-based resin, or the like is used as a base polymer, and a crosslinking agent such as an isocyanate compound, an epoxy compound, or an aziridine compound is added thereto can be applied.

Preferably, the description regarding the pressure-sensitive adhesive layer in the OLED display device described later can be applied.

### [Adjacent Layer]

The light absorption filter according to the embodiment of the present invention includes an adjacent layer directly disposed on at least one surface of the above-described wavelength selective absorption layer, and the adjacent layer contains a resin having a basic group.

The adjacent layer may be provided on only one surface of the wavelength selective absorption layer in the light absorption filter according to the embodiment of the present invention or the optical filter according to the embodiment of the present invention or may be provided on both surfaces thereof.

The above-described adjacent layer is not particularly limited. However, for example, a layer containing a resin having a basic compound may be provided, as the adjacent layer, on a layer (hereinafter, referred to as “the layer which is typically used in the display device”) which is typically used in a display device such as an organic electroluminescent display device, an inorganic electroluminescent display device, or a liquid crystal display device, which will be described later. Specifically, the adjacent layer can be obtained by containing a resin having a basic group in a gas barrier layer, a diffusion inhibiting layer, a pressure-sensitive adhesive layer or an antireflection layer, an adhesive layer, or a refractive index adjusting layer, which will be described later.

In addition, a layer which is different from the layer that is usually used in the display device and contains a resin having a basic group can also be incorporated as the adjacent layer.

### <Resin Having Basic Group>

In the light absorption filter according to the embodiment of the present invention, it is considered that the resin having a basic group, which is contained in the above-described adjacent layer, is unevenly distributed in the adjacent layer in the vicinity of the interface between the adjacent layer and the wavelength selective absorption layer, and the basic group forms a hydrogen bond with the acid group contained in the resin A contained in the wavelength selective absorption layer, thereby improving the adhesiveness.

The resin having a basic group contained in the adjacent layer is not particularly limited as long as it is a resin having a group or a structure exhibiting basicity (in the present invention, these are collectively referred to as a “basic group”), and it is possible to improve the adhesiveness of the light absorption filter according to the embodiment of the present invention.

In the present invention, the resin having a basic group means that a polymer constituting the resin includes a basic group.

The polymer constituting the resin having a basic group may be an organic basic group or an inorganic basic group, and is preferably a polymer containing an organic basic group and more preferably a polymer containing an organic basic group containing a nitrogen atom (a polymer containing a nitrogen-containing basic group).

The organic basic group preferably has a structure in which pKaH (pKa of a conjugate acid) is 4 or more. The upper limit value of the pKa of the conjugate acid is not particularly limited; however, it is practically 13 or less. It is noted that pKa has the same meaning as pKa in the compound B described above.

Examples of the organic basic group having a pKaH (pKa of a conjugate acid) of 4 or more include an unsubstituted amino group (—NH₂, a primary amino group), a substituted secondary or tertiary amino group (an amino group having at least one substituent), and a nitrogen-containing aromatic ring group. In addition, the substituents on the nitrogen atom of the secondary or tertiary amino group having the above-described substituent may be bonded to each other to form a ring structure other than the aromatic ring.

Preferred specific examples of the organic basic group having a pKaH (pKa of a conjugate acid) of 4 or more include groups consisting of nitrogen-containing aromatic rings such as guanidine, pyridine, aminopyridine, aminoalkylpyridine, aminopyrrolidine, indazole, imidazole, pyrazole, pyrazine, pyrimidine, purine, imidazoline, pyrazoline, piperazine, aminomorpholine, and aminoalkylmorpholine. Preferred examples of the substituent which may be contained in these organic basic groups include an unsubstituted amino group, an alkylamino group, an aminoaryl group, an arylamino group, an alkyl group (particularly preferably an aminoalkyl group as a substituted alkyl group), an alkoxy group, an acyl group, an acyloxy group, an aryl group, an aryloxy group, a nitro group, a hydroxy group, and a cyano group.

Among these, particularly preferred examples of the organic basic group include groups consisting of nitrogen-containing aromatic rings such as guanidine, 1,1-dimethylguanidine, 1,1,3,3,-tetramethylguanidine, imidazole, 2-methylimidazole, 4-methylimidazole, N-methylimidazole, 2-phenylimidazole, 4,5-diphenylimidazole, 2,4,5-triphenylimidazole, 2-aminopyridine, 3-aminopyridin, 4-aminopyridine, 4-dimethylaminopyridine, 2-diethylaminopyridine, 2-amino-3-methylpyridine, 2-amino-4-methylpyridine, 2-(aminomethyl)pyridine, 2-amino-5-methylpyridine, 2-amino-6-methylpyridine, 3-aminoethylpyridin, 4-aminoethylpyridine, 3-aminopyrrolidine, piperazine, N-(2-aminoethyl)piperazine, N-(2-aminoethyl) piperidine, 4-amino-2,2,6,6-tetramethylpiperidine, 4-piperidinopiperidine, 2-iminopiperidine, 1-(2-aminoethyl) pyrrolidine, pyrazole, 3-amino-5-methylpyrazole, 5-amino-3-methyl-1-p-tolylpyrazole, pyrazine, 2-(aminomethyl)-5-methylpyrazine, pyrimidine, 2,4-diaminopyrimidine, 4,6-dihydroxypyrimidine, 2-pyrazoline, 3-pyrazoline, N-aminomorpholine, and N-(2-aminoethyl) morpholine. However, the liquid crystal cell is not limited thereto.

Examples of the polymer having a nitrogen-containing aromatic ring group as the organic basic group include a polymer having a group consisting of a nitrogen-containing aromatic ring described above, and preferred examples thereof include polyvinylpyridine.

Specific examples of the polymer containing an amino group selected from an unsubstituted amino group and a secondary or tertiary amino group having a substituent as the organic basic group include polyethyleneimine and a polymeric polyamine other than polyethyleneimine (hereinafter, also simply referred to as a “polymeric polyamine”), and it is preferable to use at least one of polyethyleneimine or a polymeric polyamine.

The polymeric polyamine means a polymer having two or more amino groups selected from the above-described unsubstituted amino group and the secondary or tertiary amino group having a substituent. The polymeric polyamine is preferably a linear polymer having two or more amino groups selected from the above-described unsubstituted amino group and the secondary or tertiary amino group having a substituent, more preferably a linear polymer including a constitutional unit having, in a side chain, an amino group selected from the above-described unsubstituted amino group and the secondary or tertiary amino group having a substituent, still more preferably a linear polymer including a constitutional unit having, in a side chain, an unsubstituted amino group, and particularly preferably a linear vinyl polymer including a constitutional unit having, in a side chain, an unsubstituted amino group.

The above-described constitutional unit having an unsubstituted amino group in a side chain is not particularly limited, and examples thereof include a constitutional unit derived from N-vinylamine or allylamine, where a constitutional unit derived from N-vinylamine or allylamine is preferable.

The constitutional unit having a secondary or tertiary amino group having a substituent in a side chain is not particularly limited, and examples thereof include a constitutional unit derived from a derivative of N-vinylamine such as N-vinylformamide, a constitutional unit derived from diallylamine, and a constitutional unit derived from a derivative of allylamine such as alkoxycarbonylated allylamine or urea-modified allylamine.

In addition, the polymeric polyamine may have a constitutional unit other than the constitutional unit having an unsubstituted amino group in the side chain and the constitutional unit having a substituent in the side chain, which is a secondary or tertiary amino group, and examples thereof include a constitutional unit derived from a diallylamine derivative such as diallyldialkylammonium salt.

In the linear polymeric polyamine, the content of the constitutional unit (preferably, the constitutional unit having the above-described unsubstituted amino group in the side chain) having, in the side chain, an amino group selected from the above-described unsubstituted amino group and the secondary or tertiary amino group having a substituent is, for example, preferably 10 to 100 mol %, more preferably 20 to 100 mol %, and still more preferably 50 to 100 mol %.

As the polyethyleneimine, it is possible to preferably use, for example, EPOMIN SP-200, EPOMIN HM-2000, EPOMIN P-1000, and EPOMIN P-3000, all of which are product names and manufactured by Nippon Shokubai Co., Ltd., and Polyethyleneimine 10000 and Polyethyleneimine 70000, which are manufactured by Junsei Chemical Co., Ltd. In addition, polyethyleneimine manufactured by FUJIFILM Wako Pure Chemical Corporation can also be preferably used.

In addition, as the above-described polymeric polyamine, for example, all of which are product names, PVAM-0570B, PVAM-0595B, and PVDL manufactured by Mitsubishi Chemical Corporation, and PAA-15C, PAA-25, PAA-1222, PAA-U5000, PAA-N5000, PAS-21, and PAA-D11 manufactured by Nitto Bo Medical Co., Ltd. can be preferably used.

The weight-average molecular weight (Mw) of the polymer constituting the resin having the basic group is preferably 5,000 or more, more preferably 5,000 to 200,000, and still more preferably 5,000 to 150,000.

The content of the resin having a basic group in the adjacent layer is preferably 0.5 parts by mass or more, more preferably 0.75 parts by mass or more, still more preferably 1.0 parts by mass or more, and particularly preferably 1.5 parts by mass or more with respect to 100 parts by mass of the total amount of the components other than the resin having a basic group constituting the adjacent layer. The upper limit value thereof is preferably 45 parts by mass or less, more preferably 30 parts by mass or less, still more preferably 20 parts by mass or less, and particularly preferably 15 parts by mass or less. The preferred range of the content of the resin having a basic group in the adjacent layer is, for example, preferably 0.5 to 45 parts by mass, more preferably 0.75 to 30 parts by mass, still more preferably 1.0 to 20 parts by mass, and particularly preferably 1.5 to 15 parts by mass with respect to 100 parts by mass of the total amount of the components other than the resin having a basic group constituting the adjacent layer. The content of the resin having a basic group in the total mass of 100% by mass of the adjacent layer is, for example, preferably 0.5% to 30% by mass, more preferably 0.75% to 25% by mass, still more preferably 1.0% to 15% by mass, and particularly preferably 1.5% to 10% by mass. By adjusting the content of the resin having a basic group in the adjacent layer, it is possible to ensure good adhesiveness while maintaining the transparency of the light absorption filter.

### <Film Thickness of Light Absorption Filter According to Embodiment of Present Invention>

The film thickness of the light absorption filter according to the embodiment of the present invention is not particularly limited, but is preferably 1.5 to 20 μm, more preferably 1.5 to 15 μm, and still more preferably 2 to 10 μm.

In the present invention, the film thickness of 1.5 to 20 μm means that the thickness of the light absorption filter according to the embodiment of the present invention is within a range of 1.5 to 20 μm regardless of the site where the thickness is measured. The same applies to the film thicknesses of 1.5 to 15 μm and 2 to 10 μm. The film thickness can be measured with an electronic micrometer manufactured by Anritsu Corporation.

### <Absorbance of Light Absorption Filter of According to Embodiment of Present Invention>

In the light absorption filter according to the embodiment of the present invention, an absorbance at a maximal absorption wavelength at which the dye exhibits the highest absorbance (hereinafter, also simply referred to as “Ab(λₘₐₓ)”) is preferably 0.3 or more, more preferably 0.5 or more, and still more preferably 0.7 or more.

However, the absorbance of the light absorption filter according to the embodiment of the present invention can be adjusted by the kind, the adding amount, or the film thickness of the dye contained in the wavelength selective absorption layer in the light absorption filter according to the embodiment of the present invention.

In a case where the light absorption filter according to the embodiment of the present invention has a decolorization property, the decolorization rate of the light absorption filter according to the embodiment of the present invention due to ultraviolet irradiation is preferably 35% or more, more preferably 45% or more, and still more preferably 55% or more, among which 70% or more is particularly preferable. The upper limit value thereof is not particularly limited, and it is preferably 100%.

The decolorization rate is calculated according to the following expression using the values of Ab(λₘₐₓ) before and after the ultraviolet irradiation test.

Decolorization rate (%)=100−(Ab(λₘₐₓ) after ultraviolet irradiation/Ab(λₘₐₓ)

before ultraviolet irradiation)×100%

Here, in the ultraviolet irradiation test, an ultra-high pressure mercury lamp (for example, manufactured by HOYA Corporation, product name: UL750) is used under atmospheric pressure (101.33 kPa) to irradiate the light absorption filter with ultraviolet rays at an illuminance of 100 mW/cm² and an irradiation amount of 2,000 mJ/cm² at room temperature (25° C.).

The absorbance, the ultraviolet irradiation test, and the decolorization rate can be measured and calculated for the light absorption filter according to the embodiment of the present invention according to the methods described in Examples.

In addition, in a case where the light absorption filter according to the embodiment of the present invention has a decolorization property, it is preferable that the light absorption filter according to the embodiment of the present invention hardly causes absorption (secondary absorption) derived from a new coloration structure associated with the decomposition of the dye.

For example, the presence or absence of the absorption derived from the new coloration structure associated with the decomposition of the dye can be checked based on the ratio of the absorbance at a specific wavelength to the above Ab(λₘₐₓ). As the specific wavelength, a wavelength at which the dye hardly absorbs before ultraviolet irradiation and new absorption due to the decomposition of the dye is observed is selected.

As a specific example, as described in Examples described later, the presence or absence of the absorption derived from a new coloration structure associated with the decomposition of the dye can be checked based on the ratio of the absorbance at a wavelength of 450 nm to the above Ab(λₘₐₓ) (hereinafter, also simply referred to as “Ab (450)”). That is, it is meant that the smaller the value obtained by subtracting the ratio of the following (I) from the ratio of the following (II), the less frequently the absorption derived from the new coloration structure associated with the decomposition of the dye occurs. This value is preferably less than 8.5%, more preferably 7.0% or less, and still more preferably 5.0% or less. The lower limit value thereof is not particularly limited; however, it is practically-10% or more and preferably-6% or more from the viewpoint of making valid the evaluation related to the presence or absence of the secondary absorption associated with the decomposition of the dye.

{Ab(450) before ultraviolet irradiation/Ab(λₘₐₓ) before ultraviolet irradiation}×100% (I)

{Ab(450) after ultraviolet irradiation/Ab(λₘₐₓ) before ultraviolet irradiation}×100% (II)

For the checking of the presence or absence of the absorption derived from the new coloration structure associated with the decomposition of the dye, the calculation can be carried out based on Ab (λₘₐₓ) and Ab (450) which are measured according to the method described in Examples.

In a case where the light absorption filter according to the embodiment of the present invention has a decolorization property, the light absorption filter according to the embodiment of the present invention can exhibit an excellent decolorization property in a case where both the above-described decolorization rate and the above-described value for checking the presence or absence of the absorption derived from the new coloration structure associated with the decomposition of the dye satisfy a preferred range.

The light absorptive portion having a light absorption effect in the optical filter according to the embodiment of the present invention preferably satisfies the above description of Ab(λₘₐₓ) related to the light absorption filter according to the embodiment of the present invention.

### <Optical Functional Film>

The light absorption filter according to the embodiment of the present invention may appropriately have any optical functional film such as the following gas barrier layer, as long as the effect of the present invention is not impaired.

The optional optical functional film is not particularly limited in terms of any of the optical properties and the materials, and a film containing (or containing as a main component) at least any of a cellulose ester resin, an acrylic resin, a cyclic olefin resin, or a polyethylene terephthalate resin can be preferably used. It is noted that an optically isotropic film or an optically anisotropic phase difference film may be used.

For the above optional optical functional films, for example, Fujitac TD80UL (product name, manufactured by FUJIFILM Corporation) or the like can be used as a film containing a cellulose ester resin.

Regarding the optional optical functional film, as those containing an acrylic resin, an optical film containing a (meth)acrylic resin containing a styrene-based resin described in JP4570042B, an optical film containing a (meth)acrylic resin having a glutarimide ring structure in a main chain described in JP5041532B, an optical film containing a (meth)acrylic resin having a lactone ring structure described in JP2009-122664A, and an optically functional film containing a (meth)acrylic resin having a glutaric anhydride unit described in JP2009-139754A can be used.

In addition, regarding the optional optical functional films, as those containing a cyclic olefin resin, cyclic olefin-based resin film described in paragraphs and subsequent paragraphs of JP2009-237376A, and cyclic olefin resin film containing an additive reducing Rth described in JP4881827B, and JP2008-063536A can be used.

### <Gas Barrier Layer>

The light absorption filter according to the embodiment of the present invention may have a gas barrier layer on at least one surface of the wavelength selective absorption layer. In a case where the light absorption filter according to the embodiment of the present invention has a gas barrier layer, the light absorption filter according to the embodiment of the present invention can be made to be a light absorption filter that achieves both an excellent decolorization property and excellent light resistance and can be suitably used in the production of an optical filter described later.

In the light absorption filter according to the embodiment of the present invention, it is preferable to have a gas barrier layer as an adjacent layer directly disposed on at least one surface of the wavelength selective absorption layer.

The material that forms the gas barrier layer is not particularly limited, and examples thereof include an organic material (preferably a crystalline resin) such as polyvinyl alcohol or polyvinylidene chloride, an organic-inorganic hybrid material such as a sol-gel material, and an inorganic material such as SiO₂, SiOₓ, SiON, SiNₓ, or Al₂O₃. The gas barrier layer may be a single layer or a multilayer. In the case of a multilayer, examples thereof include configurations such as an inorganic dielectric multilayer film and a multilayer film obtained by alternately laminating organic-based materials and inorganic-based materials.

In a case where the light absorption filter according to the embodiment of the present invention includes the gas barrier layer at least on a surface that comes into contact with air in a case where the light absorption filter according to the embodiment of the present invention is used, it is possible to suppress a decrease in the light absorption intensity (absorbance) of the dye in the light absorption filter according to the embodiment of the present invention. As long as the gas barrier layer is provided at an interface of the light absorption filter according to the embodiment of the present invention in contact with air, the gas barrier layer may be provided on only one surface of the light absorption filter according to the embodiment of the present invention, or may be provided on both surfaces.

Among the above, in a case of a configuration in which the gas barrier layer contains a crystalline resin, the gas barrier layer contains a crystalline resin, and it is preferable that the thickness of the layer is 0.1 μm to 10 μm and the oxygen permeability of the layer is 60 cc/m²·day· atm or less.

In the gas barrier layer, the “crystalline resin” is a resin having a melting point that undergoes a phase transition from a crystal to a liquid in a case where the temperature is raised, and it can impart gas barrier properties related to oxygen gas to the gas barrier layer.

### (Crystalline Resin)

The crystalline resin contained in the gas barrier layer is a crystalline resin having gas barrier properties, and it can be used without particular limitation as long as a desired oxygen permeability can be imparted to the gas barrier layer.

Examples of the crystalline resin include polyvinyl alcohol and polyvinylidene chloride, and the polyvinyl alcohol is preferable from the viewpoint that a crystalline portion can effectively suppress the permeation of gas.

The polyvinyl alcohol may be modified or may not be modified. Examples of the modified polyvinyl alcohol include modified polyvinyl alcohol into which a group such as an acetoacetyl group and a carboxy group is introduced.

The saponification degree of the polyvinyl alcohol is preferably 80.0% by mole or more, more preferably 90.0% by mole or more, still more preferably 97.0% by mole or more, and particularly preferably 98.0% by mole or more, from the viewpoint of further enhancing the oxygen gas barrier properties. The upper limit value thereof is not particularly limited; however, it is practically 99.99% by mole or less. The saponification degree of the polyvinyl alcohol is a value calculated based on the method described in JIS (Japanese Industrial Standards) K 6726 1994.

The gas barrier layer may contain any component generally contained in the gas barrier layer within a range where the effect of the present invention is not impaired. For example, in addition to the above crystalline resin, organic-inorganic hybrid materials such as an amorphous resin material and a sol-gel material, and inorganic materials such as SiO₂, SiOₓ, SiON, SiNₓ, and Al₂O₃ may be contained.

Further, the gas barrier layer may contain a solvent such as water and an organic solvent derived from a manufacturing step within a range where the effect of the present invention is not impaired.

The content of the crystalline resin in the gas barrier layer is, for example, preferably 90% by mass or more and more preferably 95% by mass or more in 100% by mass of the total mass of the gas barrier layer. The upper limit value thereof is not particularly limited, and it can be set to 100% by mass.

In a case where the gas barrier layer is provided as the adjacent layer, the content of the crystalline resin in the gas barrier layer is preferably 70% to 99.5% by mass, more preferably 75% to 99.25% by mass, still more preferably 85% to 99% by mass, and particularly preferably 90% to 98.5% by mass.

The oxygen permeability of the gas barrier layer is preferably 60 cc/m²·day·atm or less, more preferably 50 cc/m²·day·atm or less, still more preferably 30 cc/m²·day·atm or less, and particularly preferably 10 cc/m²·day·atm or less. Among the above, it is preferably 5 cc/m²·day·atm or less and most preferably 1 cc/m²·day·atm or less. The practical lower limit value thereof is 0.001 cc/m²·day·atm or more, and it is preferably, for example, more than 0.05 cc/m²·day·atm. In a case where the oxygen permeability is within the above-described preferred range, the light resistance can be further improved.

The oxygen permeability of the gas barrier layer is a value measured based on the gas permeability test method based on JIS K 7126-2 2006. As the measuring device, for example, an oxygen permeability measuring device OX-TRAN2/21 (product name) manufactured by MOCON can be used. The measurement conditions are set to a temperature of 25° C. and a relative humidity of 50%.

For the oxygen permeability, (fm)/(s·Pa) can be used as the SI unit. It is possible to carry out the conversion by (1 fm)/(s·Pa)=8.752 (cc)/(m²·day·atm). fm is read as femtometer and represents 1 fm=10⁻¹⁵ m.

The thickness of the gas barrier layer is preferably 0.1 μm to 5 μm, and more preferably 0.1 μm to 4.0 μm, from the viewpoint of further improving the light resistance.

The thickness of the gas barrier layer is measured by a method of capturing a cross-sectional image using a field emission scanning electron microscope S-4800 (product name) manufactured by Hitachi High-Tech Corporation.

The degree of crystallinity of the crystalline resin contained in the gas barrier layer is preferably 25% or more, more preferably 40% or more, and still more preferably 45% or more. The upper limit value thereof is not particularly limited, and it is practically 55% or less and preferably 50% or less.

The degree of crystallinity of the crystalline resin contained in the gas barrier layer is a value measured and calculated according to the following method based on the method described in J. Appl. Pol. Sci., 81, 762 (2001).

Using a differential scanning calorimeter (DSC), a temperature of a sample peeled from the gas barrier layer is raised at 10° C./min over the range of 20° C. to 260° C., and a heat of fusion 1 is measured. Further, as a heat of fusion 2 of the perfect crystal, the value described in J. Appl. Pol. Sci., 81, 762 (2001) is used. Using the obtained heat of fusion 1 and heat of fusion 2, the degree of crystallinity is calculated according to the following expression.

[Degree of crystallinity(%)]=([heat of fusion 1]/[heat of fusion 2])×100

The heat of fusion 1 and heat of fusion 2 may have the same unit, which is generally Jg⁻¹.

### <Manufacturing Method for Gas Barrier Layer>

The method of forming the gas barrier layer is not particularly limited, and examples thereof include a producing method according to a conventional method according to a casting method such as spin coating or slit coating, for example, in a case of an organic material. In addition, examples thereof can include a method of bonding a commercially available resin gas barrier film or a resin gas barrier film produced in advance to the light absorption filter according to the embodiment of the present invention. In addition, in a case of an inorganic material, examples thereof include a plasma enhanced chemical vapor deposition (CVD) method, a sputtering method, and a vapor deposition method.

In a case where the above-described gas barrier layer is provided in the light absorption filter according to the embodiment of the present invention, for example, a method of directly producing the above-described gas barrier layer on the light absorption filter according to the embodiment of the present invention produced according to the above-described production method is included. In this case, it is also preferable to apply a corona treatment to the surface of the light absorption filter according to the embodiment of the present invention to which the gas barrier layer is provided.

In addition, in a case where the above-described optional optical functional film is provided, it is also preferable to carry out bonding while interposing a pressure-sensitive adhesive layer. For example, it is also preferable that a gas barrier layer is provided on the light absorption filter according to the embodiment of the present invention and then bonded to an optical functional film while interposing a pressure-sensitive adhesive layer.

In a case of being provided as an adjacent layer in the light absorption filter according to the embodiment of the present invention, the above-described gas barrier layer or optical functional film can be provided in the same manner as described above except that it is provided to serve as a gas barrier layer containing a resin having a basic group with respect to the wavelength selective absorption layer in the light absorption filter according to the embodiment of the present invention.

### <Diffusion Inhibiting Layer>

In the light absorption filter according to the embodiment of the present invention, a diffusion inhibiting layer may be provided between the wavelength selective absorption layer and the support. The diffusion of the components in the wavelength selective absorption layer into the support can be suppressed by the diffusion inhibiting layer, and particularly, in the light absorption filter I according to the embodiment of the present invention, the decolorization property upon ultraviolet irradiation can be improved.

The diffusion of the wavelength selective absorption layer component into the support may occur in any of a process of forming the wavelength selective absorption layer and a process after forming the wavelength selective absorption layer. In particular, at the time of forming the wavelength selective absorption layer, the influence of the swelling of the support due to the solvent in the coating liquid for a wavelength selective absorption layer and the increase in the free volume in the support is large. From this viewpoint, it is preferable that the diffusion inhibiting layer has low affinity for the solvent used in the formation of the wavelength selective absorption layer. For example, in a case where the resin constituting the diffusion inhibiting layer is a material in which a component such as a dye contained in the wavelength selective absorption layer or a compound that generates a radical upon ultraviolet irradiation is dissolved in an organic solvent (non-aqueous solvent), the resin constituting the diffusion inhibiting layer is preferably a resin having low affinity for an organic solvent, that is, a water-soluble resin.

The affinity between the solvent used for the wavelength selective absorption layer and the resin constituting the diffusion inhibiting layer can be evaluated by a solubility parameter &t calculated according to the Hoy method. For example, the solubility parameter St can be calculated by a method described in the column of “2) Method of Hoy (1985, 1989)” on pages 214 to 220 of the literature “Properties of Polymers 3^{rd}, ELSEVIER, (1990)”.

In the present invention, the absolute value of the difference between the &t value of the solvent used in the formation of the wavelength selective absorption layer and the &t value of the resin constituting the diffusion inhibiting layer is preferably 1.0 or more, more preferably 2.0 or more, and still more preferably 3.0 or more. It is preferable to adjust the absolute value of the difference between the δt value of the solvent used in the formation of the wavelength selective absorption layer and the δt value of the resin constituting the diffusion inhibiting layer to be equal to or greater than the above-described preferred value, since in a case where a liquid forming the wavelength selective absorption layer is applied onto the diffusion inhibiting layer, the solvent contained in the liquid forming the wavelength selective absorption layer is suppressed from permeating the diffusion inhibiting layer, and the swelling of the support is effectively suppressed.

### (Resin)

As the resin constituting the diffusion inhibiting layer, a water-soluble resin is preferable. The water-soluble resin may be any of a thermosetting resin or a thermoplastic resin, and in a case where the water-soluble resin is a thermoplastic resin, the water-soluble resin may be crystalline or non-crystalline.

For example, as the water-soluble resin, polyvinyl alcohol, polyvinylpyridine, a (meth)acrylic resin, polyurethane, polyester, an epoxy resin, a cellulose resin, or the like can be preferably used. At least one part of these water-soluble resins may be modified.

The polyvinyl alcohol may be modified or may not be modified. Examples of the modified polyvinyl alcohol include modified polyvinyl alcohol into which a group such as an acetoacetyl group and a carboxy group is introduced.

From the viewpoint of further enhancing the barrier properties (permeation suppression performance) of the organic solvent, the saponification degree of the polyvinyl alcohol is preferably 60.0 mol % or more, more preferably 80.0 mol % or more, and still more preferably 90.0 mol % or more. The upper limit value thereof is not particularly limited; however, it is practically 99.99% by mole or less. The saponification degree of the polyvinyl alcohol is a value calculated based on the method described in JIS K 6726 (1994).

The above-described (meth)acrylic resin may be any resin including at least one of a constitutional unit derived from (meth)acrylic acid or a constitutional unit derived from a (meth)acrylic acid ester, and a resin including a constitutional unit derived from (meth)acrylic acid is preferable. The proportion of the constitutional unit derived from (meth)acrylic acid in all constitutional units constituting the (meth)acrylic resin is preferably 70 to 100 mol %, more preferably 80 to 100 mol %, and still more preferably 90 to 100 mol %.

Among these, from the viewpoint that the crystal portion can effectively suppress the permeation of solvent molecules and the viewpoint that swelling due to the organic solvent used in the wavelength selective absorption layer is unlikely to occur, as the resin constituting the diffusion inhibiting layer, at least one of a polyvinyl alcohol or a (meth)acrylic resin is preferably used, and at least one of a polyvinyl alcohol or a poly(meth)acrylic acid is more preferably used.

The content of the resin (preferably, the water-soluble resin) in the diffusion inhibiting layer is, for example, preferably 90% by mass or more and more preferably 95% by mass or more. The upper limit value thereof is not particularly limited, and it can be set to 100% by mass.

From the viewpoint of further improving the diffusion inhibition ability, the thickness of the diffusion inhibiting layer is preferably 0.1 to 5.0 μm and more preferably 0.2 to 4.0 μm.

### (Method for Producing Diffusion Inhibiting Layer)

A method of forming the diffusion inhibiting layer is not particularly limited, and examples thereof include a method of preparing the diffusion inhibiting layer on a support by a casting method such as spin coating or slit coating according to a conventional method.

The solvent used in this case can be used without particular limitation as long as a desired diffusion inhibiting layer can be obtained. For example, in a case where the resin constituting the diffusion inhibiting layer is a water-soluble resin, a water-soluble solvent such as water, ethanol, or isopropyl alcohol can be preferably used.

Regarding the support, the description of the support in the coating method described above can be applied as it is.

### (Matting Agent)

In order to impart sliding properties and prevent blocking, fine particles may be added to the surface of the light absorption filter according to the embodiment of the present invention as long as the effect of the present invention is not impaired. As the fine particles, silica (silicon dioxide, SiO₂) of which the surface is coated with a hydrophobic group and which has an aspect of secondary particles is preferably used. As the fine particles, in addition to or instead of silica, fine particles of titanium dioxide, aluminum oxide, zirconium oxide, calcium carbonate, talc, clay, calcined kaolin, calcined calcium silicate, hydrated calcium silicate, aluminum silicate, magnesium silicate, and calcium phosphate may be used. Examples of the commercially available product of the fine particles include the R972 or NX90S (product name, both manufactured by Nippon Acrosil Co., Ltd.).

The fine particles function as a so-called matting agent, and the addition of the fine particles forms minute unevenness on the surface of the light absorption filter according to the embodiment of the present invention. Due to the unevenness, even in a case where the light absorption filters according to the embodiment of the present invention overlap with each other or the light absorption filter according to the embodiment of the present invention and other films overlap with each other, the films do not stick to each other and sliding properties are secured.

In a case where the light absorption filter according to the embodiment of the present invention contains a matting agent as fine particles, the effect of improving sliding properties and blocking properties is particularly large in the fine unevenness due to the protrusions in which fine particles protrude from the filter surface in a case where there are 104/mm² or more of protrusions having a height of 30 nm or more.

It is preferable to apply the matting agent (fine particles) particularly onto the surface layer in order to improve the blocking properties and the sliding properties. Examples of the method of applying fine particles onto the surface layer include methods such as multilayer casting and coating.

The content of the matting agent in the light absorption filter according to the embodiment of the present invention is appropriately adjusted depending on the intended purpose.

### [Optical Filter]

In a case where the light absorption filter according to the embodiment of the present invention has a decolorization property, the optical filter according to the embodiment of the present invention is obtained by subjecting the light absorption filter according to the embodiment of the present invention to mask exposure by ultraviolet irradiation.

Examples of the light absorption filter having a decolorization property among the light absorption filters according to the embodiment of the present invention include the light absorption filter I according to the embodiment of the present invention, in which the wavelength selective absorption layer contains the above-described dye and the above-described resin A having an acid group, and the above-described compound B that forms a hydrogen bond with the acid group contained in the resin A and generates a radical upon ultraviolet irradiation, and a light absorption filter containing the above-described dye and the above-described resin A having an acid group, and the above-described photoradical generator in the wavelength selective absorption layer.

In a case of being simply referred to as the light absorption filter according to the embodiment of the present invention in the following explanatory description related to the optical filter and the explanatory description related to the manufacturing method for the optical filter, it means the light absorption filter having a decolorization property according to the embodiment of the present invention.

The wavelength selective absorption layer in the optical filter according to the embodiment of the present invention has a light absorptive portion having a light absorption effect and a portion in which light absorption absorbability has been eliminated (an absorbability-eliminated portion) in response to a mask exposure pattern (hereinafter, also referred to as a “mask pattern”).

That is, in a case where the light absorption filter according to the embodiment of the present invention is subjected to mask exposure by ultraviolet irradiation, the masked portion of the wavelength selective absorption layer in the light absorption filter according to the embodiment of the present invention is not exposed and present as a light absorptive portion having a light absorption effect, whereas the unmasked portion is exposed and is converted to an absorbability-eliminated portion.

The light absorptive portion can exhibit a desired absorbance.

In addition, the absorbability-eliminated portion can exhibit optical characteristics close to colorlessness since the wavelength selective absorption layer in the light absorption filter according to the embodiment of the present invention exhibits an excellent decolorization rate and moreover, secondary absorption seldom occurs in association with the decomposition of the dye.

### <Manufacturing Method for Optical Filter>

The optical filter according to the embodiment of the present invention can be obtained by irradiating the light absorption filter according to the embodiment of the present invention with an ultraviolet ray to carry out mask exposure.

The mask pattern can be appropriately adjusted so that the optical filter according to the embodiment of the present invention having a desired pattern consisting of a light absorptive portion and a light absorbability-eliminated portion can be obtained.

The conditions of ultraviolet irradiation can be appropriately adjusted so that the optical filter according to the embodiment of the present invention having a light absorbability-eliminated portion can be obtained. For example, the ultraviolet irradiation can be carried out under atmospheric pressure (101.33 kPa) regarding the pressure condition and can be carried out under a mild temperature condition regarding the temperature condition without carrying out heating at room temperature (10° C. to 30° C.) or the like, the lamp output can be set to 80 to 320 W/cm, and an air-cooled metal halide lamp, a mercury lamp such as an ultra-high pressure mercury lamp, or the like can be used as a lamp to be used. In addition, the irradiation amount can be set to 200 to 2,000 mJ/cm².

The optical filter according to the embodiment of the present invention may have an optical functional film described in the light absorption filter according to the embodiment of the present invention.

In addition, the optical filter according to the embodiment of the present invention may have a layer containing an ultraviolet absorbing agent. As the ultraviolet absorbing agent, a commonly used compound can be used without particular limitation, and examples thereof include an ultraviolet absorbing agent in the ultraviolet absorbing layer described later. The resin constituting the layer containing the ultraviolet absorbing agent is also not particularly limited, and examples thereof include a resin in the ultraviolet absorbing layer described later.

The content of the ultraviolet absorbing agent in the layer containing the ultraviolet absorbing agent is appropriately adjusted according to the intended purpose.

The optical filter according to the embodiment of the present invention can be used for display devices such as an organic electroluminescent display device, an inorganic electroluminescent display device, and a liquid crystal display device. In a case where the optical filter according to the embodiment of the present invention includes a gas barrier layer, it is preferable that the optical filter is disposed such that the gas barrier layer is positioned on the outer light side with respect to the wavelength selective absorption layer, in a case where the optical filter is used in any of the display devices.

### [OLED Display Device]

The organic electroluminescent display device according to the embodiment of the present invention (referred to as an organic electroluminescence (EL) display device or an organic light emitting diode (OLED) display device, and abbreviated as an OLED display device in the present invention) includes the optical filter according to the embodiment of the present invention.

As another configuration of the OLED display device according to the embodiment of the present invention, the configuration of the generally used OLED display device can be used without particular limitation, as long as the optical filter according to the embodiment of the present invention is included. The configuration example of the OLED display device according to the embodiment of the present invention is not particularly limited, and examples thereof include a display device including glass, a layer containing a thin film transistor (TFT), an OLED display element, a barrier film, a color filter, glass, a pressure-sensitive adhesive layer, the optical filter according to the embodiment of the present invention, and a surface film, in order from the opposite side to external light.

The OLED display element has a configuration in which an anode electrode, a light emitting layer, and a cathode electrode are laminated in this order. In addition to the light emitting layer, a hole injection layer, a hole transport layer, an electron transport layer, an electron injection layer, and the like are included between the anode electrode and the cathode electrode. In addition, for example, the description in JP2014-132522A can also be referenced.

In addition, as the color filter, in addition to a typical color filter, a color filter in which quantum dots are laminated can also be used.

A resin film can be used instead of the above glass.

### <Pressure-Sensitive Adhesive Layer>

In the OLED display device according to the embodiment of the present invention, a surface of the optical filter according to the embodiment of the present invention on the external light side may be bonded to an optical functional film having an antireflection layer or the like with a pressure-sensitive adhesive layer being interposed. In addition, it is preferable that a surface of the optical filter according to the embodiment of the present invention, which is positioned opposite to the side of the external light, is bonded to the glass (the base material) with a pressure-sensitive adhesive layer being interposed.

For the pressure-sensitive adhesive layer, the descriptions related to the pressure-sensitive adhesive layer and the forming method in the OLED display device, which are described in to of WO2021/132674A, can be applied as they are.

It is noted that the pressure-sensitive adhesive composition described in WO2021/132674A preferably contains the above-described ultraviolet absorbing agent from the viewpoint of the light resistance of the optical filter.

### <Base Material>

In the OLED display device according to the embodiment of the present invention, a surface of the optical filter according to the embodiment of the present invention, which is positioned on the external light side, may be bonded to any optical functional film with a pressure-sensitive adhesive layer being interposed. In addition, it is preferable that a surface of the optical filter according to the embodiment of the present invention, which is positioned opposite to the side of the external light, is bonded to the glass (the base material) with a pressure-sensitive adhesive layer being interposed.

The method of forming the adhesive layer is not particularly limited, and for example, a method of applying the pressure-sensitive adhesive composition to the light absorption filter or optical filter according to the embodiment of the present invention by a usual means such as a bar coater, drying, and curing the pressure-sensitive adhesive composition; a method of applying the pressure-sensitive adhesive composition first to the surface of a peelable base material, and drying the composition, and then transferring the pressure-sensitive adhesive layer using the peelable base material to the light absorption filter according to the embodiment of the present invention and then aging and curing the composition is used.

The peelable base material is not particularly limited, and a predetermined peclable base material can be used. Examples thereof include the support film in the manufacturing method for the light absorption filter according to the embodiment of the present invention described above.

In addition, the conditions of application, drying, aging, and curing can be appropriately adjusted based on a conventional method.

### [Inorganic Electroluminescent Display Device]

An inorganic electroluminescent display device (referred to as an inorganic EL (electroluminescence) display device and also simply referred to as an inorganic EL display device in the present invention) according to an embodiment of the present invention includes the optical filter according to the embodiment of the present invention.

As another configuration of the inorganic EL display device according to the embodiment of the present invention, a configuration of a generally used inorganic EL display device can be used without particular limitation as long as the optical filter according to the embodiment of the present invention is included. For example, the descriptions regarding the inorganic EL element and the inorganic electroluminescent display device, which are described in JP2005-338640A can be preferably applied.

### [Liquid Crystal Display Device]

The liquid crystal display device according to the embodiment of the present invention includes the optical filter according to the embodiment of the present invention.

The optical filter according to the embodiment of the present invention may be used as at least one of a polarizing plate-protective film or a pressure-sensitive adhesive layer as described later, or it may be included in a backlight unit that is used in the liquid crystal display device.

It is preferable that the liquid crystal display device includes the optical filter according to the embodiment of the present invention, a polarizing plate including a polarizer and a polarizing plate-protective film, a pressure-sensitive adhesive layer, and a liquid crystal cell, where it is preferable that the polarizing plate is bonded to the liquid crystal cell with a pressure-sensitive adhesive layer being interposed. In the liquid crystal display device, the optical filter according to the embodiment of the present invention may also serve as the polarizing plate-protective film or the pressure-sensitive adhesive layer. That is, the liquid crystal display device is divided into a case where the liquid crystal display device includes a polarizing plate including a polarizer and the optical filter (polarizing plate-protective film) according to the embodiment of the present invention, a pressure-sensitive adhesive layer, and a liquid crystal cell, and a case where the liquid crystal display device includes a polarizing plate including a polarizer and a polarizing plate-protective film, the optical filter (pressure-sensitive adhesive layer) according to the embodiment of the present invention, and a liquid crystal cell.

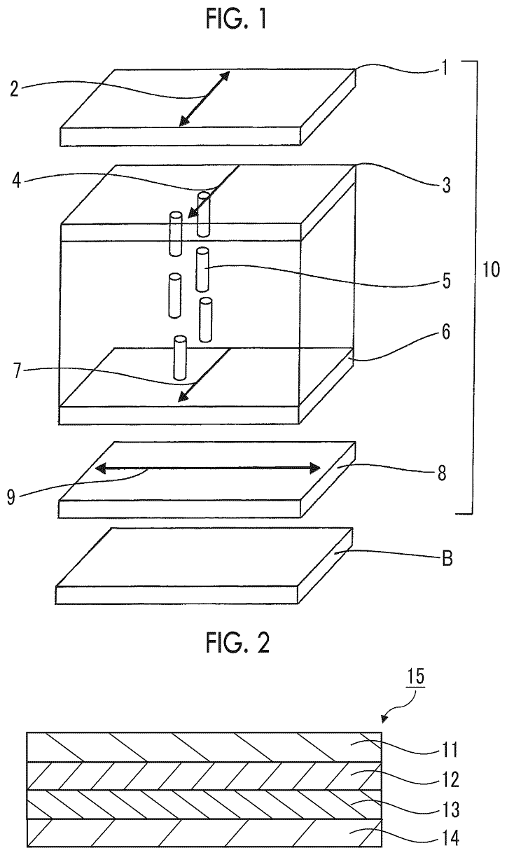

FIG. 1 is a schematic view illustrating an example of the liquid crystal display device according to the embodiment of the present invention. In FIG. 1, a liquid crystal display device 10 consists of a liquid crystal cell having a liquid crystal layer 5 and having a liquid crystal cell upper electrode substrate 3 and a liquid crystal cell lower electrode substrate 6, which are respectively disposed above and below the liquid crystal layer 5, and an upper polarizing plate 1 and a lower polarizing plate 8, which are respectively disposed on both sides of the liquid crystal cell. A color filter layer may be laminated on the upper electrode substrate 3 or the lower electrode substrate 6. On the rear surface of the liquid crystal display device 10, a backlight is disposed. As a light source of the backlight, those described in the above backlight unit can be used.

Each of the upper polarizing plate 1 and the lower polarizing plate 8 has a configuration in which each of them is laminated such that a polarizer is sandwiched between two polarizing plate protective films, and in the liquid crystal display device 10, at least one polarizing plate is preferably a polarizing plate including the optical filter according to the embodiment of the present invention.

In addition, in the liquid crystal display device 10, the liquid crystal cell may be bonded to the polarizing plates (the upper polarizing plate 1 and/or the lower polarizing plate 8) with a pressure-sensitive adhesive layer (not illustrated in the drawing) being interposed. In this case, the optical filter according to the embodiment of the present invention may also serve as the above-described pressure-sensitive adhesive layer.

The liquid crystal display device 10 includes an image direct vision-type liquid crystal display, an image projection-type liquid crystal display device, and a light modulation-type liquid crystal display device. The present invention is effective for an active matrix liquid crystal display device that uses a three-terminal or two-terminal semiconductor element such as a thin film transistor (TFT) or a metal insulator metal (MIM). Of course, it is also effective for a passive matrix liquid crystal display device represented by a super twisted nematic (STN) mode which is called as the time division driving.

In a case where the optical filter according to the embodiment of the present invention is included in the backlight unit, the polarizing plate of the liquid crystal display device may be a general polarizing plate (a polarizing plate that does not include the optical filter according to the embodiment of the present invention) or may be a polarizing plate that includes the optical filter according to the embodiment of the present invention. In addition, the pressure-sensitive adhesive layer may be a typical pressure-sensitive adhesive layer (not the optical filter according to the embodiment of the present invention) or may be a pressure-sensitive adhesive layer formed of the optical filter according to the embodiment of the present invention.

The in-plane switching (IPS) mode liquid crystal display device described in paragraphs 0128 to 0136 of JP2010-102296A is preferable as the liquid crystal display device according to the embodiment of the present invention except that the optical filter according to the embodiment of the present invention is used.

### <Polarizing Plate>

The polarizing plate that is used in the present invention includes a polarizer and at least one polarizing plate-protective film.

The polarizing plate that is used in the present invention is preferably a polarizing plate having a polarizer and polarizing plate-protective films on both surfaces of the polarizer, and it is preferable that at least one surface of the polarizer includes the optical filter according to the embodiment of the present invention as the polarizing plate-protective film. In this case, the surface of the polarizer opposite to the surface having the optical filter according to the embodiment of the present invention (the polarizing plate-protective film according to the embodiment of the present invention) may have a general polarizing plate-protective film.

The film thickness of the polarizing plate protective film is preferably 5 to 120 μm and more preferably 10 to 100 μm. A thinner film is preferable since in a case of being incorporated in the liquid crystal display device, the display unevenness after elapse of time in high temperature and high humidity is less likely to occur. On the other hand, a thicker film is preferable from the viewpoint of stable transportation during film manufacturing and polarizing plate production. In a case where the optical filter according to the embodiment of the present invention also serves as the polarizing plate-protective film, it is preferable that the thickness of the optical filter satisfies the above-described range.

For the polarizing plate that is used in the present invention, the descriptions related to the performance, the shape, the configuration, the polarizer, the method of laminating the polarizer and the polarizing plate-protective film, the functionalization of the polarizing plate, and the like regarding the polarizing plate described in to of WO2021/132674A can be applied as they are.

### <Pressure-Sensitive Adhesive Layer>

In the liquid crystal display device according to the embodiment of the present invention, the polarizing plate is preferably bonded to the liquid crystal cell with a pressure-sensitive adhesive layer being interposed. The optical filter according to the embodiment of the present invention may also serve as the pressure-sensitive adhesive layer. In a case where the optical filter according to the embodiment of the present invention does not serve as the pressure-sensitive adhesive layer, a typical pressure-sensitive adhesive layer can be used as the pressure-sensitive adhesive layer.

The pressure-sensitive adhesive layer is not particularly limited as long as the polarizing plate can be bonded to the liquid crystal cell, and for example, an acrylic type, a urethane type, polyisobutylene, or the like is preferable.

In a case where the optical filter according to the embodiment of the present invention also serves as a pressure-sensitive adhesive layer, the pressure-sensitive adhesive layer includes the dye, the resin A containing an acid group, and the base polymer, and further contains a crosslinking agent, a coupling agent, or the like to impart adhesiveness. Among the resins A containing an acid group, a resin that functions as a base polymer in the pressure-sensitive adhesive layer may be used as a base polymer.

In a case where the optical filter according to the embodiment of the present invention also serves as a pressure-sensitive adhesive layer, the above-described base polymer to be contained in the pressure-sensitive adhesive layer is preferably 90% by mass or more and less than 100% by mass, and more preferably 95% by mass or more and less than 100% by mass. The content of the dye is as described above.

The thickness of the pressure-sensitive adhesive layer is not particularly limited; however, it is preferably 1 to 50 μm and more preferably 3 to 30 μm.

### <Liquid Crystal Cell>

The liquid crystal cell is not particularly limited, and a typical liquid crystal cell can be used.

### <Ultraviolet Absorbing Layer>

The organic electroluminescent display device, inorganic electroluminescent display device, or liquid crystal display device including the optical filter according to the embodiment of the present invention preferably has a layer (hereinafter, also referred to as an “ultraviolet absorbing layer”) that inhibits the light absorption (ultraviolet absorption) of the compound B which forms a hydrogen bond with the acid group contained in the resin A and generates a radical upon ultraviolet irradiation, on the viewer side with respect to the optical filter according to the embodiment of the present invention. In a case where the ultraviolet absorbing layer is provided, it is possible to prevent the fading of the optical filter according to the embodiment of the present invention due to external light.

Hereinafter, the ultraviolet absorbing layer that is used in the present invention will be described.

### (Ultraviolet Absorbing Agent)

The ultraviolet absorbing layer usually contains a resin and an ultraviolet absorbing agent. From the viewpoint of the excellent absorption capacity of an ultraviolet ray having a wavelength of 370 nm or less and good liquid crystal display properties, an ultraviolet absorbing agent having a small absorption of visible light having a wavelength of 400 nm or more is preferably used.

Specific examples of the ultraviolet absorbing agent preferably used in the present invention include a hindered phenol-based compound, a benzophenone-based compound such as a hydroxybenzophenone-based compound, a benzotriazole-based compound, a salicylic acid ester-based compound, a cyanoacrylate-based compound, and a nickel complex salt-based compound.

Examples of the hindered phenol-based compound include 2,6-di-tert-butyl-p-cresol, pentaerythrityl-tetrakis [3-(3,5-di-tert-butyl-4-hydroxyphenyl) propionate], N,N′-hexamethylene bis(3,5-di-tert-butyl-4-hydroxy-hydrocinnamide), 1,3,5-trimethyl-2,4,6-tris(3,5-di-tert-butyl-4-hydroxybenzyl)benzene, and tris-(3,5-di-tert-butyl-4-hydroxybenzyl)-isocyanurate.

Examples of the benzotriazole-based compound include 2-(2′-hydroxy-5′-methylphenyl)benzotriazole, 2,2-methylene bis(4-(1,1,3,3-tetramethylbutyl)-6-(2H-benzotriazole-2-yl) 2,4-bis(n-octylthio)-6-(4-hydroxy-3,5-di-tert-butylanilino)-1,3,5-triazine, triethyleneglycol-bis[3-(3-tert-butyl-5-methyl-4-hydroxyphenyl) propionate], phenol), N,N′-hexamethylene bis(3,5-di-tert-butyl-4-hydroxy-hydrocinnamide), 1,3,5-trimethyl-2,4,6-tris(3,5-di-tert-butyl-4-hydroxybenzyl)benzene, 2-(2′-hydroxy-3′,5′-Di-tert-butylphenyl)-5-chlorbenzotriazole, 2-(2′-hydroxy-3′,5′-di-tert-amylphenyl)-5-chlorbenzotriazole, 2,6-di-tert-butyl-p-cresol, and pentaerythrityl-tetrakis[3-(3,5-di-tert-butyl-4-hydroxyphenyl) propionate].

The adding amount of this ultraviolet absorbing agent is preferably 0.1 parts by mass to 30.0 parts by mass with respect to 100 parts by mass of the resin.

In addition, from the viewpoint of further improving the light resistance of the optical filter according to the embodiment of the present invention, it is also preferable to use the compound (1) represented by Formula (1) described in paragraphs to of WO2023/068235A as the ultraviolet absorber. For the absorption characteristics, the synthesis method, and the content of the compound (1) represented by Formula (1) described in WO2023/068235A, paragraphs to of WO2023/068235A can also be suitably used in the present invention.

### (Resin)

As the resin that is used for the ultraviolet absorbing layer, a commonly used resin can be used, which is not particularly limited as long as it does not contradict the gist of the present invention. Examples of the resin include a cellulose acylate resin, an acrylic resin, a cycloolefin-based resin, a polyester-based resin, and an epoxy resin.

### (Installation Position of Ultraviolet Absorbing Layer)

The disposition of the ultraviolet absorbing layer is not particularly limited as long as it is on the viewer side with respect to the optical filter according to the embodiment of the present invention, and the ultraviolet absorbing layer can be installed at any position. For example, it is also possible to add an ultraviolet absorbing agent to a member such as a protective film of the polarizing plate, an antireflection film, or the like to impart it a function of an ultraviolet absorbing layer. In addition, an ultraviolet absorbing agent can also be added to the above-described pressure-sensitive adhesive layer.

### EXAMPLES

Hereinafter, the present invention will be described in more detail based on Examples. The materials, using amount, ratio, details of treatment, procedures of treatment, and the like described in Examples below can be appropriately changed without departing from the spirit of the present invention. Therefore, it is to be understood that the scope of the present invention is not limited to Examples described below.

It is noted that “parts” and “%” that indicate the composition in Examples below are based on mass unless otherwise specified. Room temperature means “25° C.”.

It is noted that all steps from a step of preparing a wavelength selective absorption layer forming liquid to a step of producing a base material-attached light absorption filter and a step of carrying out an ultraviolet irradiation test using the light absorption filter were carried out under a yellow lamp so that the ultraviolet irradiation was not allowed.

### EXAMPLES

### [Production of Light Absorption Filter]

Materials used to produce the light absorption filter are shown below.

### <Polymer (Resin)>

### (Resin 1)

A cyclohexyl methacrylate-methacrylic acid random copolymer, methacrylic acid content: 40% by mole, weight-average molecular weight: 53500.

### (Resin 2)

A cyclohexyl methacrylate-methacrylic acid random copolymer, methacrylic acid content: 50% by mole, weight-average molecular weight: 46400.

### (Resin 3)

A cyclohexyl methacrylate-methacrylic acid random copolymer, methacrylic acid content: 60% by mole, weight-average molecular weight: 43800.

### (Resin 4)

A cyclohexyl methacrylate-methacrylic acid random copolymer, methacrylic acid content: 70% by mole, weight-average molecular weight: 49900.

### (Resin 5)

Adamantyl methacrylate-acrylic acid random copolymer, acrylic acid content: 52 mol %, weight-average molecular weight: 46300.

The (meth)acrylic acid moiety of each of the resins 1 to 5 corresponds to the acid group included in the resin A defined in the present invention.

### <Compound B>

4-methylquinoline (manufactured by Tokyo Chemical Industry Co., Ltd., Lepidine, pKaH: 5.1)

### <Dye>

In the following structural formulae, Bu represents a butyl group.

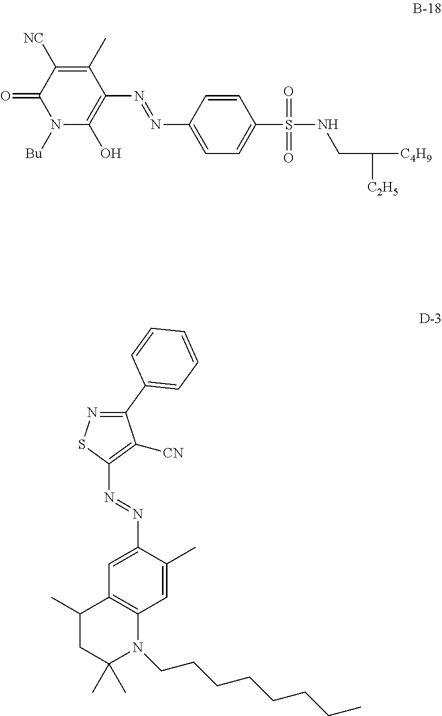

### (Leveling Agent 1)

A polymer surfactant composed of the following constitutional components was used as a leveling agent 1. In the following structural formulae, the proportion of each constitutional component is in terms of a molar ratio, and t-Bu means a tert-butyl group.

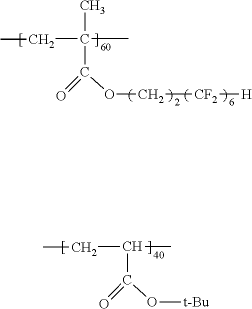

### (Base Material 1)

A cellulose acylate film (manufactured by FUJIFILM Corporation, product name: ZRD40SL)

### Example 1

<1. Production of Base Material 1 with Diffusion Inhibiting Layer>

### (1) Preparation of Diffusion Inhibiting Layer Forming Liquid (Resin Solution)

Each component was mixed with the composition shown below, stirred in a constant-temperature tank at 50° C. for 1 hour, and poly(methacrylic acid) (manufactured by FUJIFILM Wako Pure Chemical Corporation, weight-average molecular weight: about 100,000) was dissolved to prepare a diffusion inhibiting layer forming liquid.

Composition of diffusion inhibiting layer forming liquid

| | |
|---|---|
| Poly(methacrylic acid) (manufactured by FUJIFILM | 4.0 parts |
| Wako Pure Chemical Corporation, weight-average | by mass |
| molecular weight about 100000) | |
| Pure water | 60.0 parts |
| | by mass |
| Ethanol | 36.0 parts |
| | by mass |

Subsequently, the obtained diffusion inhibiting layer forming liquid was filtered using a filter having an absolute filtration precision of 5 μm (product name: Hydrophobic Fluorepore Membrane, manufactured by Millex).

### (2) Production of Diffusion Inhibiting Layer

A base material 1 was coated with the diffusion inhibiting layer forming liquid after the filtration treatment using a bar coater such that the film thickness after drying was 1.1 μm, and dried at 120° C. for 60 seconds to produce the base material 1 with a diffusion inhibiting layer.

### <2. Production of Light Absorption Filter No. 101>

### (1) Preparation of Wavelength Selective Absorption Layer Forming Liquid (Resin Solution)

Each component was mixed according to the composition shown below to prepare a wavelength selective absorption layer forming liquid Ba-2.

Composition of wavelength selective
absorption layer forming liquid Ba-2

| | |
|---|---|
| Resin 1 | 76.8 parts |
| | by mass |
| Leveling agent 1 | 0.08 parts |
| | by mass |
| Dye D-3 | 3.05 parts |
| | by mass |
| Dye B-18 | 2.85 parts |
| | by mass |
| 4-methylquinoline (manufactured by | 17.2 parts |
| Tokyo Chemical Industry Co., Ltd.) | by mass |
| Methyl ethyl ketone (solvent) | 566.7 parts |
| | by mass |

Subsequently, the obtained light wavelength selective absorption layer forming liquid Ba-2 was filtered using a filter paper (#63, manufactured by Toyo Roshi Kaisha, Ltd.) having an absolute filtration precision of 10 μm, and further subjected to filtration using a metal sintered filter (product name: Pall filter PMF, media code: FH025, manufactured by Pall) with an absolute filtration precision of 2.5 μm.

### (2) Production of Light Absorption Filter

The wavelength selective absorption layer forming liquid Ba-2 after the filtration treatment was applied to the diffusion inhibiting layer side of the base material 1 with a diffusion inhibiting layer using a bar coater so that the film thickness after drying was 2.5 μm, and dried at 120° C., thereby producing a light absorption filter No. 101.

<3. Production of Light Absorption Filters Nos. 102 to 105 and r201>

Light absorption filter Nos. 102 to 105 according to the embodiment of the present invention were produced in the same manner as in the production of the light absorption filter No. 101, except that in the production of the light absorption filter No. 101, the resin 1 constituting the wavelength selective absorption layer was changed to the resin shown in Table 1 for the same number of parts by mass.

In addition, a light absorption filter No. r201 was produced in the same manner as in the production of the light absorption filter No. 105, except that, in the production of the light absorption filter No. 105, the dye D-3, the dye B-18, and 4-methylquinoline were excluded from the wavelength selective layer absorption layer forming liquid.

### [Production of Light Absorption Filter Having Gas Barrier Layer]

Regarding each of the light absorption filters Nos. 101 to 105 and r201, a light absorption filter (a light absorption filter having a gas barrier layer) formed by further laminating a gas barrier layer on the light absorption filter was produced as described below, and the evaluation described later was carried out.

### (1) Preparation of Gas Barrier Layer Forming Liquid (Resin Solution)

Each component was adjusted to have a compositional ratio shown below, and then, Kuraray Exceval AQ-4105 (product name, manufactured by Kuraray Co., Ltd., modified polyvinyl alcohol, saponification degree: 98% to 99% by mole) was dissolved in pure water and isopropyl alcohol by stirring in a constant temperature tank at 90° C. for 1 hour, cooled to room temperature, polyethyleneimine (manufactured by FUJIFILM Wako Pure Chemical Corporation, weight-average molecular weight: about 10,000) was added thereto, and a gas barrier layer forming liquid was prepared.

Composition of gas barrier layer forming liquid

| | |
|---|---|
| Kuraray Exceval AQ-4105 (product name, manufactured | 3.8 parts |
| by KURARAY Co., Ltd.) | by mass |
| Polyethyleneimine (manufactured by FUJIFILM Wako | 0.2 parts |
| Pure Chemical Corporation, weight-average molecular | by mass |
| weight: about 10000) | |
| Pure water | 88.5 parts |
| | by mass |
| Isopropyl alcohol | 7.5 parts |
| | by mass |

Subsequently, the obtained gas barrier layer forming liquid was filtered using a filter having an absolute filtration precision of 5 μm (product name: Hydrophobic Fluorepore Membrane, manufactured by Millex).

### (2) Lamination of Gas Barrier Layer

The gas barrier layer forming liquid after the filtration treatment was applied to the wavelength selective absorption layer side of the light absorption filter using a bar coater such that the film thickness after drying was 0.3 μm, and dried at 130° C. for 60 seconds, thereby preparing a light absorption filter having a gas barrier layer.

As shown in FIG. 2, the light absorption filter having the gas barrier layer has a configuration in which the base material 1 (14), a diffusion inhibiting layer 13, a wavelength selective absorption layer 12, and a gas barrier layer 11 are laminated in this order.

Here, Nos. 101 to 105 are the light absorption filters according to the embodiment of the present invention, and No. r201 is a light absorption filter for reference.

### <4. Production of Light Absorption Filter No. 106 Having Gas Barrier Layer>

A light absorption filter No. 106 having a gas barrier layer was produced in the same manner as in the production of the light absorption filter No. 101, except that, in the production of the light absorption filter No. 101 having a gas barrier layer, the polyethyleneimine added to the gas barrier layer was replaced with a poly(N-vinylamine)-based resin (manufactured by Mitsubishi Chemical Corporation, product name: PVAM-0570B, weight-average molecular weight: 100000) in terms of parts by mass.

Here, No. 106 is the light absorption filter according to the embodiment of the present invention.

<5. Production of Light Absorption Filters No. c202 and c203 Having Gas Barrier Layer>

A light absorption filter No. c202 having a gas barrier layer of Comparative Example was produced in the same manner as in the production of the light absorption filter No. 101, except that polyethyleneimine was not added to the gas barrier layer in the production of the light absorption filter No. 101 having a gas barrier layer.

In addition, a light absorption filter No. c203 having a gas barrier layer of Comparative Example was produced in the same manner as in the production of the light absorption filter No. 104, except that polyethyleneimine was not added to the gas barrier layer in the production of the light absorption filter No. 104 having a gas barrier layer.

### <Evaluation of Physical Properties of Gas Barrier Layer>

In any case where 5% by mass of the polyethyleneimine (manufactured by FUJIFILM Wako Pure Chemical Corporation, weight-average molecular weight: about 10,000) or poly(N-vinylamine) resin (manufactured by Mitsubishi Chemical Corporation, product name: PVAM-0570B, weight-average molecular weight: 100,000) was added, the physical properties of the gas barrier layer measured by the method described in to of WO2022/149510A were a degree of crystallinity of 47%, an oxygen permeability of 2.5 cc/m²·day atm, and a thickness of 0.3 μm.

### [1. Adhesiveness]

A light absorption filter having a gas barrier layer was cut into a size of a width of 25 mm and a length of 150 mm, and the gas barrier layer side of the light absorption filter was bonded to glass through a pressure-sensitive adhesive (product name: SK2057, manufactured by Soken Chemical & Engineering Co., Ltd.) having a width of 30 mm and a length of 100 mm, thereby preparing an adhesiveness evaluation film. In the light absorption filter having a gas barrier layer, the size of the bonding surface between the pressure-sensitive adhesive and the light absorption filter having a gas barrier layer was 25 mm in width and 100 mm in length, and the pressure-sensitive adhesive and the glass were bonded to each other to protrude (not bonded to the pressure-sensitive adhesive) by 25 mm in width and 50 mm in length.

Subsequently, a 90-degree peeling test was performed at a peeling rate of 300 mm/min under a condition of 25° C. according to JIS standard: JIS Z-0237 (2009). Specifically, in the adhesiveness evaluation film obtained as described above, a cut was made with a cutter at a boundary portion between a portion of the light absorption filter having a gas barrier layer, which was bonded to the pressure-sensitive adhesive, and a portion of the light absorption filter having a gas barrier layer, which was not bonded to the pressure-sensitive adhesive, from the gas barrier layer side to the diffusion inhibiting layer that is the layer in front of the base material such that the cut did not reach the base material, the cut having a width of 25 mm. A portion of the light absorption filter having a gas barrier layer that was not bonded to the glass was gripped, and a portion of the light absorption filter having a gas barrier layer that was bonded to the glass was peeled off by 50 mm in a direction perpendicular to the glass surface toward a side opposite to the glass side, and the peeling force at that time was measured with a tensile tester.

In the above test, an average value (average peeling force) of the peeling forces from a position where 20 mm peeling was performed to a position where 50 mm peeling was performed was calculated, and the adhesiveness was evaluated according to the following standard based on the average peeling force.

The adhesiveness between the glass and the gas barrier layer in the light absorption filter due to the pressure-sensitive adhesive is sufficiently higher than the adhesiveness between each layer constituting the light absorption filter, and the average peeling force obtained by the above test is the peeling force between two layers that are most easily peeled off among each layer constituting the light absorption filter.

### —Evaluation Standards—

A: average peeling force was 5 N/25 mm or more.
B: average peeling force was 2 N/25 mm or more and less than 5 N/25 mm.
C: average peeling force was less than 2 N/25 mm.

The results are shown in Table 1.

TABLE 1

| | Resin A in | Resin having basic group | | |
|---|---|---|---|---|
| Light absorption | wavelength | in gas barrier layer | | |
| filter No. having | selective | | Adding | |
| gas barrier layer | absorption layer | Kind | amount | Adhesiveness |
| 101 | 1 | Polyethyleneimine | 5% | B |
| 102 | 2 | Polyethyleneimine | 5% | A |
| 103 | 3 | Polyethyleneimine | 5% | A |
| 104 | 4 | Polyethyleneimine | 5% | A |
| 105 | 5 | Polyethyleneimine | 5% | A |
| 106 | 1 | Poly(N-vinylamine) | 5% | A |
| r201 | 5 | Polyethyleneimine | 5% | A |
| c202 | 1 | — | — | C |
| c203 | 4 | — | — | C |

(Note in table)
Resins 1 to 5: Resins 1 to 5 described above, respectively
Polyethyleneimine: manufactured by FUJIFILM Wako Pure Chemical Corporation, weight-average molecular weight: about 10,000
Poly(N-vinylamine): poly(N-vinylamine)-based resin, manufactured by Mitsubishi Chemical Corporation, product name: PVAM-0570B, weight-average molecular weight: 100000
Adding amount: indicates a content proportion of the resin having a basic group in the gas barrier layer, based on mass
“—”: Indicates that the gas barrier layer does not contain a resin having a basic group.

From the results in Table 1, it can be seen that the light absorption filters Nos. 101 to 106 according to the embodiment of the present invention, which have the gas barrier layer as the adjacent layer defined in the present invention, exhibit excellent adhesiveness. On the other hand, in the light absorption filters Nos. c202 and c203 of Comparative Examples, the gas barrier layer which is an adjacent layer directly disposed on one surface of the wavelength selective absorption layer does not contain a resin having a basic group, and thus does not satisfy the definition of the present invention. In the light absorption filter Nos. c202 and c203 of these comparative examples, the adhesiveness was insufficient, and peeling occurred easily at the interface between the wavelength selective absorption layer and the gas barrier layer.

### [2. Decolorization Rate]

The decolorization rate of the light absorption filters Nos. 101 to 106 having a gas barrier layer was evaluated.

### (Ultraviolet Irradiation Test)

At room temperature, the light absorption filter having a gas barrier layer and the standard filter were irradiated with ultraviolet rays (UV) at an illuminance of 100 mW/cm² and an irradiation amount of 2000 mJ/cm² from the gas barrier layer side (the side opposite to the base material 1) by using an ultra-high pressure mercury lamp (manufactured by HOYA Corporation, product name: UL750) under atmospheric pressure (101.33 kPa).

### <Absorbance of Light Absorption Filter (Before and After Ultraviolet Irradiation)>

For each of the light absorption filter and the standard filter having a gas barrier layer before and after ultraviolet irradiation, the absorbance Ab (λ) of each of the light absorption filter and the standard filter before and after ultraviolet irradiation was calculated as follows.

### (1) Measurement of Absorbance

Using a UV3600 spectrophotometer (product name) manufactured by Shimadzu Corporation, the absorbance of the light absorption filter having a gas barrier layer and the standard filter in a wavelength range of 380 to 800 nm was measured for every 1 nm.

The standard filter for the light absorption filters Nos. 101 to 106, c202, and c203 containing the resins 1 to 5 is a light absorption filter No. r201 which has been changed not to contain the dye and the compound B. Since there was no difference in the absorbance values of the resins 1 to 5 in the wavelength range of 380 to 800 nm, the light absorption filter No. r201 was used as a standard filter for all the light absorption filters.

### (2) Calculation of Absorbance

Using the absorbance value Abₓ(λ) of the light absorption filter having a gas barrier layer at each wavelength 2 nm measured as described above and the absorbance value Ab₀(λ) of the standard filter containing the same resin at each wavelength 2 nm, the absorbance Ab (λ) of the light absorption filter before ultraviolet irradiation was calculated according to the following expression.

$$Ab ( λ ) = A {b}_{x} ( λ ) - {Ab}_{0} ( λ )$$

Hereinafter, among the absorbances Ab (λ) of the light absorption filter in a wavelength range of 400 to 700 nm, the wavelength at which the highest absorbance Ab (λ) among the wavelengths at which the highest maximal absorption is exhibited was defined as the maximal absorption wavelength (hereinafter, also simply referred to as “Δₘₐₓ”), and the absorbance at Δₘₐₓ was defined as the absorption maximal value (hereinafter, also simply referred to as “Ab(λₘₐₓ)”).

The above-described maximal absorption wavelength and absorption maximum value were determined for each of the dye B-18 and the dye D-3, and the color decolorization rate described later was evaluated for each dye.

### (3) Evaluation of Decolorization Rate

The decolorization rate was calculated according to the following expression using the absorption maximal values (Ab(λₘₐₓ)) before and after the ultraviolet irradiation test.

$$Decolorization rate ( \% ) = 100 - ( Ab ( {λ}_{max} ) after ultraviolet irradiation / Ab ( {λ}_{max} ) before ultraviolet irradiation ) \times 100 \%$$

The decolorization rates of the light absorption filters Nos. 101 to 106 having a gas barrier layer, which were calculated in this manner, were all 90% or more, and excellent decolorization properties were exhibited.

(4) Absorption (Secondary Absorption) Derived from New Coloration Structure, Associated with Decomposition of Dye

In the light absorption filters Nos. 101 to 106 having a gas barrier layer, a value obtained by subtracting the ratio of the following (I) from the ratio of the following (II) was 5.0% or less, and the secondary absorption associated with the decomposition of the dye due to ultraviolet irradiation was suppressed.

$$\{ Ab ( 450 ) before ultraviolet irradiation / Ab ( {λ}_{max} ) before ultraviolet irradiation \} \times 100 \% \qquad ( I )$$

$$\{ Ab ( 450 ) after ultraviolet irradiation / Ab ( {λ}_{max} ) before ultraviolet irradiation \} \times 100 \% \qquad ( II )$$

Reference Example: Production of light absorption filter containing at least any one of azo-based coloring agent represented by any one of General Formulae (i) to (iv) or indoaniline-based coloring agent represented by General Formula (v), and evaluation of decolorization property and the like

Materials and filter Nos. used in the production of the light absorption filter and the evaluation of decolorization property and the like described below are used only in the reference examples described below.

### [Production of Light Absorption Filter]

Materials used to produce the light absorption filter are shown below.

### <Polymer (Resin)>

### (Resin 1)

A cyclohexyl methacrylate-methacrylic acid random copolymer, methacrylic acid content: 29% by mole, weight-average molecular weight: 26300.

It is noted that the methacrylic acid moiety of the resin 1 corresponds to the compound A having an acid group defined in the present invention.

### <Compound B>

4-methylquinoline (manufactured by Tokyo Chemical Industry Co., Ltd., Lepidine, pKaH: 5.1)

### <Dye>

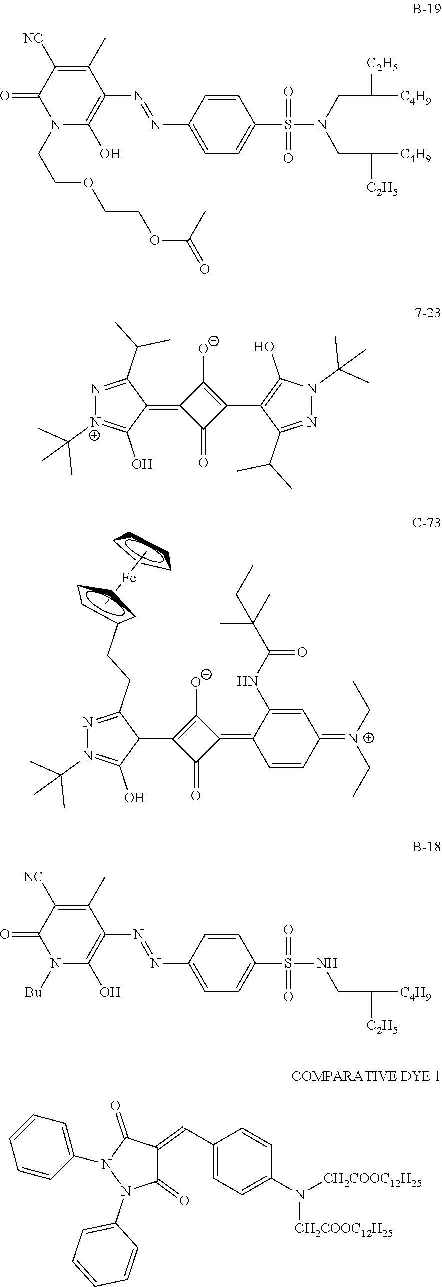

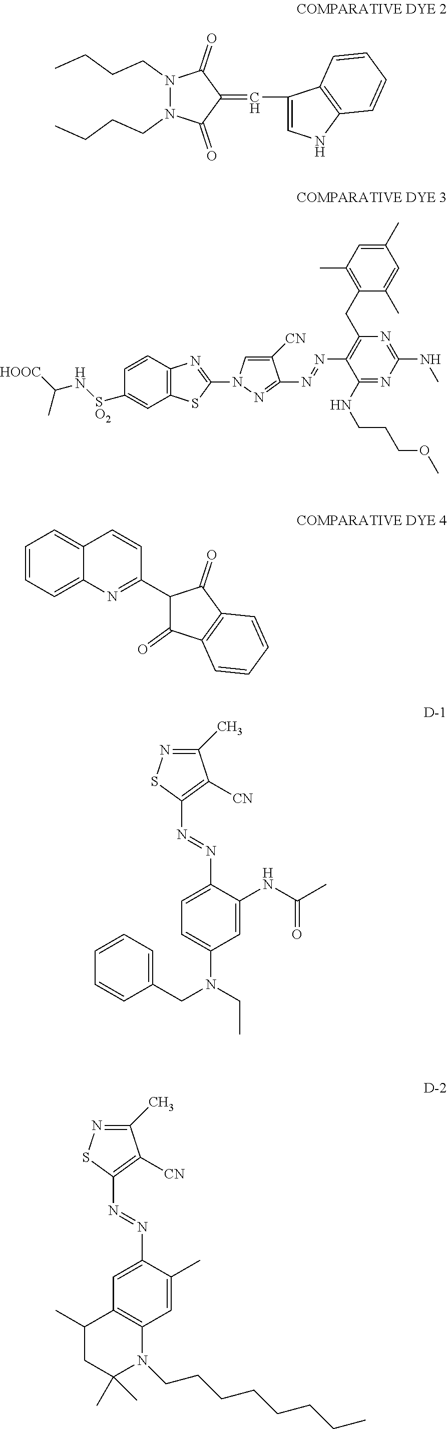

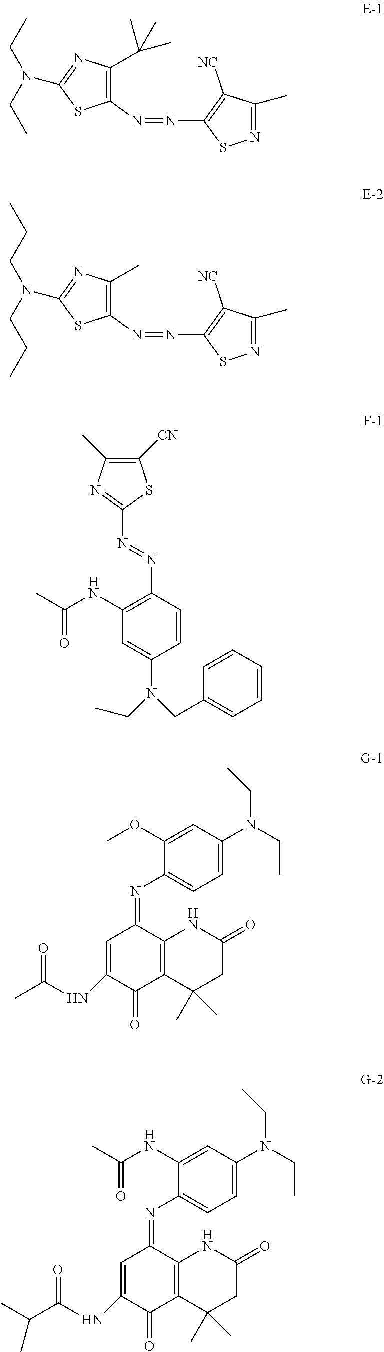

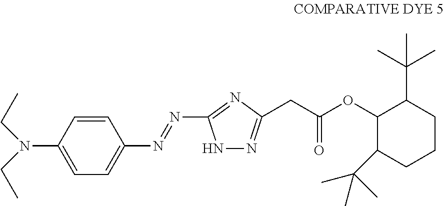 [SMILES: CCN(CC)c1ccc(/N=N/c2nc(CC(=O)OC3C(C(C)(C)C)CCCC3C(C)(C)C)n[nH]2)cc1]

### (Leveling Agent 1)

A polymer surfactant composed of the following constitutional components was used as a leveling agent 1. In the following structural formulae, the proportion of each constitutional component is in terms of a molar ratio, and t-Bu means a tert-butyl group.

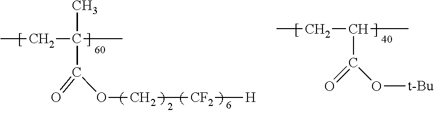

### (Base Material 1)

A polyethylene terephthalate film (manufactured by TORAY INDUSTRIES, Inc., product name: Lumirror XD-510P, film thickness: 50 μm)

### <1. Production of Light Absorption Filter No. 101>

### (1) Preparation of Resin Solution (Light Absorption Filter Forming Liquid)

Each component was mixed with the composition shown below to prepare a light absorption filter forming liquid (composition) Ba-1.

Composition of light absorption filter forming liquid Ba-1

| | |
|---|---|
| Resin 1 | 81.1 parts |
| | by mass |
| Leveling agent 1 | 0.08 parts |
| | by mass |
| Dye B-19 | 1.56 parts |
| | by mass |
| 4-methylquinoline (manufactured by | 17.2 parts |
| Tokyo Chemical Industry Co., Ltd.) | by mass |
| Methyl ethyl ketone (solvent) | 566.7 parts |
| | by mass |

Subsequently, the obtained light absorption filter forming liquid Ba-1 was filtered using a filter paper (#63, manufactured by Toyo Roshi Kaisha, Ltd.) having an absolute filtration precision of 10 μm, and further subjected to filtration using a metal sintered filter (product name: Pall filter PMF, media code: FH025, manufactured by Pall) with an absolute filtration precision of 2.5 μm.

### (2) Production of Light Absorption Filter

The light absorption filter forming liquid Ba-1 after the filtration treatment was applied onto the base material 1 by using a bar coater so that the film thickness after drying was 2.2 μm, and dried at 120° C. to produce a light absorption filter No. 101.

<2. Production of Light Absorption Filters Nos. 102 to 112, r201, and c202 to c206>

Light absorption filters Nos. 102 to 112 and c202 to c206 were produced in the same manner as in the production of the light absorption filter No. 101, except that in the production of the light absorption filter No. 101, at least any one of the kind or the blending amount of the dye was changed to the content described in Table 1A. It is noted that the adjustment is carried out such that the blending amount of the leveling agent 1 and the compound B in the light absorption filter No. 101 is fixed, the blending amount of the resin is changed according to the change in the blending amount of the dye, and the mass of the entire filter does not change.

In addition, a light absorption filter No. r201 was produced in the same manner, except that in the production of the light absorption filter No. 101, the compound B and the dye were not blended and the blending amount of the resin was changed so that the mass of the entire filter was not changed.

Here, Nos. 101 to 112 are the light absorption filters of Reference Examples, Nos. c202 to c206 are light absorption filters for comparison, and No. r201 is a light absorption filter for reference.

### [Production of Light Absorption Filter Having Gas Barrier Layer]

Regarding each of the light absorption filters Nos. 101 to 112, r201, and c202 to c206, a light absorption filter (a light absorption filter having a gas barrier layer) formed by further laminating a gas barrier layer on the light absorption filter was produced as described below, and the evaluation described later was carried out.

### (1) Production of Base Material 3

The wavelength selective absorption layer side of the base material-attached light absorption filter produced above was subjected to a corona treatment using a corona treatment device (product name: Corona-Plus, manufactured by VETAPHONE) under the conditions of a discharge amount of 1,000 W·min/m² and a processing speed of 3.2 m/min and used as a base material 3.

### (2) Preparation of Resin Solution

The respective components were according to the composition shown below, and the resultant mixture was stirred in a constant-temperature tank at 90° C. for 1 hour to dissolve Kuraray Exceval AQ-4105 (product name, manufactured by KURARAY Co., Ltd., modified polyvinyl alcohol, saponification degree: 98% to 99% by mole), whereby a gas barrier layer forming liquid was prepared.

Composition of gas barrier layer forming liquid

| | |
|---|---|
| Kuraray Exceval AQ-4105 (product name, | 4.0 parts |
| manufactured by KURARAY Co., Ltd.) | by mass |
| Pure water | 88.5 parts |
| | by mass |
| Isopropyl alcohol | 7.5 parts |
| | by mass |

Subsequently, the obtained gas barrier layer forming liquid was filtered using a filter having an absolute filtration precision of 5 μm (product name: Hydrophobic Fluorepore Membrane, manufactured by Millex).

### (3) Lamination of Gas Barrier Layer

The gas barrier layer forming liquid after the filtration treatment was applied to the corona-treated surface side of the base material 3 using a bar coater so that the film thickness after drying was 1.6 μm, and dried at 120° C. for 60 seconds, whereby a light absorption filter having a gas barrier layer was produced.

The light absorption filter having the gas barrier layer has a configuration in which the base material 1, the wavelength selective absorption layer, and the gas barrier layer are laminated in this order.

### <Evaluation of Physical Properties of Gas Barrier Layer>

The physical properties of the gas barrier layer, which had been measured by the method described in to of WO2022/149510A, were a degree of crystallinity of 53%, an oxygen permeability of 0.4 cc/m² day atm, and a thickness of 1.6 μm, respectively.

### <Absorbance of Light Absorption Filter (Before Ultraviolet Irradiation)>

### (1) Measurement of Absorbance

Using a UV3600 spectrophotometer (product name) manufactured by Shimadzu Corporation, the absorbance of the light absorption filter having a gas barrier layer and the standard filter in a wavelength range of 380 to 800 nm was measured for every 1 nm.

A standard filter for the light absorption filters Nos. 101 to 112, and c202 to c206, which contain the resin 1, is the light absorption filter No. r201 which has been changed not to contain the dye and the compound B.

### (2) Calculation of Absorbance

Using the absorbance value Abₓ(λ) of the light absorption filter having a gas barrier layer at each wavelength λ nm measured as described above and the absorbance value Ab₀(λ) of the standard filter containing the same resin at each wavelength 2 nm, the absorbance Ab (λ) of the light absorption filter before ultraviolet irradiation was calculated according to the following expression.

$$Ab ( λ ) = A {b}_{x} ( λ ) - A {b}_{0} ( λ )$$

Hereinafter, among the absorbances Ab (λ) of the light absorption filter in a wavelength range of 400 to 700 nm, the wavelength at which the highest absorbance Ab (λ) among the wavelengths at which the highest maximal absorption is exhibited was defined as the maximal absorption wavelength (hereinafter, also simply referred to as “Δₘₐₓ”), and the absorbance at Δₘₐₓ was defined as the absorption maximal value (hereinafter, also simply referred to as “Ab(λₘₐₓ)”).

It is noted that the above-described maximal absorption wavelength and absorption maximal value were determined for each of the dye A, the dye B, and the dye C, and the decolorization rate described later was evaluated for each dye. Here, the dyes B-19 and B-18, which are the azo-based coloring agents represented by General Formula (i) described above, and the comparative dyes 1 to 4 are classified into the dye A, the dye 7-23, the dye F-1 which is the azo-based coloring agent represented by General Formula (ii) described above, the dyes E-1 and E-2, which are the azo-based coloring agents represented by General Formula (iii) described above, the dyes D-1 and D-2, which are the azo-based coloring agents represented by General Formula (iv) described above, and the comparative dye 5 are classified into the dye B, and the dyes G-1 and G-2, which are the indoaniline-based coloring agents represented by General Formula (v) described above, and the dye C-73 are classified into the dye C, respectively.

### <<Evaluation 1>>

The decolorization rate of each light absorption filter was evaluated.

The results are summarized in Table 2A below.

### (Ultraviolet Irradiation Test)

At room temperature, the light absorption filter having a gas barrier layer and the standard filter were irradiated with ultraviolet rays (UV) at an illuminance of 100 mW/cm² and an irradiation amount shown in Table 1A from the gas barrier layer side (the side opposite to the base material 1) by using an ultra-high pressure mercury lamp (manufactured by HOYA Corporation, product name: UL750) under atmospheric pressure (101.33 kPa).

<Absorbance of Light Absorption Filter (after Ultraviolet Irradiation)>

Using the light absorption filter having a gas barrier layer after ultraviolet irradiation and the standard filter, the absorbance Ab (λ) of the light absorption filter after ultraviolet irradiation was calculated according to the same method as described in <Absorbance of light absorption filter (before ultraviolet irradiation)> described above.

### [1. Evaluation of Decolorization Rate]

The decolorization rate was calculated according to the following expression using the absorption maximal values (Ab(λₘₐₓ)) before and after the ultraviolet irradiation test.

$$Decolorization rate ( \% ) = 100 - ( Ab ( {λ}_{max} ) after ultraviolet irradiation / Ab ( {λ}_{max} ) before ultraviolet irradiation ) \times 100 \%$$

[2. Evaluation of Presence or Absence of Secondary Absorption Associated with Decomposition of Coloring Agent]

The presence or absence of the absorption (secondary absorption) derived from the new coloration structure associated with the decomposition of the coloring agent was evaluated based on a ratio of an absorbance at a wavelength of 450 nm (hereinafter, also simply referred to as “Ab (450)”) to the absorption maximal value (Ab(λₘₐₓ)) before ultraviolet irradiation and a ratio of an absorbance at a wavelength of 650 nm (hereinafter, also simply referred to as “Ab (650)”) to the absorption maximal value (Ab (λₘₐₓ)) before ultraviolet irradiation. It means that the smaller the value obtained by subtracting the ratio of the following (I) from the ratio of the following (II) and the value obtained by subtracting the ratio of the following (III) from the ratio of the following (IV), the less frequently the absorption derived from the new coloration structure associated with the decomposition of the coloring agent occurs.

It is noted that in the description of Table 2A described later, as a wavelength at which the coloring agent before ultraviolet irradiation seldom exhibits absorption but new absorption due to the decomposition of the coloring agent is observed, where the wavelength is a wavelength at which the presence or absence of the secondary absorption associated with the decomposition of the coloring agent can be evaluated, a wavelength of 450 nm can be selected for evaluations of Nos. 101, 105, 106, 109 to 111, and c203, and a wavelength of 650 nm can be selected for evaluations of Nos. 101 to 109, 112, and c202 to c206, respectively.

$$\{ Ab ( 450 ) before ultraviolet irradiation / Ab ( {λ}_{max} ) before ultraviolet irradiation \} \times 100 \% \qquad ( I )$$

$$\{ Ab ( 450 ) after ultraviolet irradiation / Ab ( {λ}_{max} ) before ultraviolet irradiation \} \times 100 \% \qquad ( II )$$

$$\{ Ab ( 650 ) before ultraviolet irradiation / Ab ( {λ}_{max} ) before ultraviolet irradiation \} \times 100 \% \qquad ( III )$$

$$\{ Ab ( 650 ) after ultraviolet irradiation / Ab ( {λ}_{max} ) before ultraviolet irradiation \} \times 100 \% \qquad ( IV )$$

TABLE 1A

| | Dye | | | | Compound B | | Irradiation |
|---|---|---|---|---|---|---|---|
| | | λₘₐₓ | Blending | | | Blending | amount |
| No. | Kind | (nm) | amount | Resin | Kind | amount | (mJ/cm²) |
| 101 | B-19 | 431 | 1.56 | 1 | 4-methylquinoline | 17.2 | 750 |
| 102 | B-19 | 431 | 0.85 | 1 | 4-methylquinoline | 17.2 | 1250 |
| | 7-23 | 505 | 0.72 | | | | |
| | C-73 | 593 | 1.10 | | | | |
| 103 | B-19 | 431 | 1.34 | 1 | 4-methylquinoline | 17.2 | 1500 |
| | 7-23 | 505 | 0.92 | | | | |
| | C-73 | 593 | 1.57 | | | | |
| 104 | B-18 | 431 | 1.14 | 1 | 4-methylquinoline | 17.2 | 750 |
| 105 | D-1 | 549 | 0.95 | 1 | 4-methylquinoline | 17.2 | 1000 |
| 106 | D-2 | 566 | 1.03 | 1 | 4-methylquinoline | 17.2 | 1000 |
| 107 | E-1 | 527 | 0.82 | 1 | 4-methylquinoline | 17.2 | 1000 |
| 108 | E-2 | 520 | 0.79 | 1 | 4-methylquinoline | 17.2 | 1000 |
| 109 | F-1 | 546 | 0.95 | 1 | 4-methylquinoline | 17.2 | 1000 |
| 110 | G-1 | 658 | 0.99 | 1 | 4-methylquinoline | 17.2 | 1000 |
| 111 | G-2 | 634 | 1.12 | 1 | 4-methylquinoline | 17.2 | 1000 |
| 112 | B-19 | 431 | 1.31 | 1 | 4-methylquinoline | 17.2 | 1250 |
| | E-2 | 520 | 0.46 | | | | |
| | C-73 | 593 | 1.17 | | | | |
| c202 | Comparative | 450 | 1.96 | 1 | 4-methylquinoline | 17.2 | 750 |
| | dye 1 | | | | | | |
| c203 | Comparative | 416 | 0.77 | 1 | 4-methylquinoline | 17.2 | 750 |
| | dye 2 | | | | | | |
| c204 | Comparative | 443 | 1.66 | 1 | 4-methylquinoline | 17.2 | 750 |
| | dye 3 | | | | | | |
| c205 | Comparative | 421 | 1.14 | 1 | 4-methylquinoline | 17.2 | 750 |
| | dye 4 | | | | | | |
| c206 | Comparative | 453 | 1.16 | 1 | 4-methylquinoline | 17.2 | 1000 |
| | dye 5 | | | | | | |

TABLE 2A

| | | | | | | Ratio of Ab (450) to | | | | Ratio of Ab (650) to | |
|---|---|---|---|---|---|---|---|---|---|---|---|
| | | | | | | Ab (λₘₐₓ) before | | | | Ab (λₘₐₓ) before | |
| | Decolorization | | | Ab (450) | | ultraviolet irradiation | | Ab (650) | | ultraviolet irradiation | |
| | rate | | | Before | After | Before | After | Before | After | Before | After |
| | Dye | Dye | Dye | ultraviolet | ultraviolet | ultraviolet | ultraviolet | ultraviolet | ultraviolet | ultraviolet | ultraviolet |
| No. | A | B | C | irradiation | irradiation | irradiation | irradiation | irradiation | irradiation | irradiation | irradiation |
| 101 | 93% | — | — | 0.012 | 0.012 | 5% | 5% | 0.009 | 0.005 | 3% | 2% |
| 102 | 93% | 96% | 99% | 0.195 | 0.013 | 24% | 2% | 0.008 | 0.009 | 1% | 1% |
| 103 | 90% | 93% | 97% | 0.252 | 0.030 | 24% | 3% | 0.013 | 0.015 | 1% | 1% |
| 104 | 91% | — | — | 0.220 | 0.034 | 82% | 13% | 0.005 | 0.009 | 2% | 3% |
| 105 | — | 95% | — | 0.052 | 0.006 | 14% | 2% | 0.009 | 0.009 | 2% | 2% |
| 106 | — | 96% | — | 0.028 | 0.004 | 8% | 1% | 0.012 | 0.007 | 4% | 2% |
| 107 | — | 95% | — | 0.049 | 0.005 | 17% | 2% | 0.011 | 0.012 | 4% | 4% |
| 108 | — | 95% | — | 0.061 | 0.001 | 22% | 0% | 0.007 | 0.011 | 3% | 4% |
| 109 | — | 96% | — | 0.049 | 0.004 | 16% | 1% | 0.009 | 0.011 | 3% | 4% |
| 110 | — | — | 96% | 0.007 | 0.001 | 4% | 1% | 0.146 | 0.008 | 92% | 5% |
| 111 | — | — | 96% | 0.010 | 0.001 | 5% | 0% | 0.216 | 0.009 | 99% | 4% |
| 112 | 92% | 90% | 92% | 0.277 | 0.021 | 37% | 2% | 0.007 | 0.007 | 1% | 1% |
| c202 | 84% | — | — | 0.358 | 0.058 | 100% | 16% | 0.007 | 0.005 | 2% | 1% |
| c203 | 31% | — | — | 0.031 | 0.019 | 16% | 10% | 0.007 | 0.002 | 4% | 1% |
| c204 | 56% | — | — | 0.282 | 0.126 | 97% | 43% | 0.005 | 0.008 | 2% | 3% |
| c205 | 1% | — | — | 0.330 | 0.340 | 86% | 88% | 0.011 | 0.008 | 3% | 2% |
| c206 | — | 73% | — | 0.079 | 0.021 | 100% | 27% | 0.004 | 0.006 | 5% | 8% |

(Note in table)
λₘₐₓ means a wavelength at which the highest absorbance Ab (λ) is exhibited among the maximal absorption wavelengths that the light absorption filter has in a wavelength range of 400 to 700 nm.
The blending amount of the dye and the compound B means the number of parts by mass with respect to 100 parts by mass of the wavelength selective absorption layer.
Ab (λₘₐₓ) means the value of the absorbance at the maximal absorption wavelength λₘₐₓ.
“—” in the column of decolorization rate indicates that the corresponding dye is not contained.

From the results of Tables 1A and 2A, the following can be seen.

In all of the light absorption filters Nos. c202 to c206 of Comparative Examples, which did not contain any of the azo-based coloring agent represented by any of General Formulae (i) to (iv) and the indoaniline-based coloring agent represented by General Formula (v) but contained any of the comparative dyes 1 to 5, the decolorization rate upon irradiation with UV light was low.

In contrast, in all of the light absorption filters of Reference Examples, the light absorption filters Nos. 101 to 104, containing the dye B-19 or B-18 which is an azo-based coloring agent represented by General Formula (i), the light absorption filters Nos. 105 and 106 of Reference Examples containing the dye D-1 or D-2 which is an azo-based coloring agent represented by General Formula (iv), the light absorption filters Nos. 107 and 108 of Reference Examples containing the dye E-1 or E-2 which is an azo-based coloring agent represented by General Formula (iii), No. 109 of Reference Examples containing the dye F-1 which is an azo-based coloring agent represented by General Formula (ii), Nos. 110 and 111 of Reference Examples containing the dye G-1 or G-2 which is an indoaniline-based coloring agent represented by General Formula (v), and the light absorption filter No. 112 of Reference Examples containing the dye B-19 which is an azo-based coloring agent represented by General Formula (i) and the dye E-2 which is an azo-based coloring agent represented by General Formula (iii), the decolorization rate upon UV light irradiation was high, secondary absorption associated with the decomposition of the dye upon UV light irradiation was hardly generated, and the decolorization property in a case of being irradiated with ultraviolet rays at room temperature was excellent.

The present invention has been described together with the embodiments of the present invention. However, the inventors of the present invention do not intend to limit the present invention in any part of the details of the description unless otherwise designated, and it is conceived that the present invention should be broadly construed without departing from the spirit and scope of the invention shown in the attached “WHAT IS CLAIMED IS”.

### EXPLANATION OF REFERENCES

1: upper polarizing plate
2: direction of absorption axis of upper polarizing plate
3: liquid crystal cell upper electrode substrate
4: alignment control direction of upper substrate
5: liquid crystal layer
6: liquid crystal cell lower electrode substrate
7: alignment control direction of lower substrate
8: lower polarizing plate
9: direction of absorption axis of lower polarizing plate
B: backlight unit
10: liquid crystal display device
11: gas barrier layer
12: wavelength selective absorption layer
13: diffusion inhibiting layer
14: base material 1
15: light absorption filter

What is claimed is:

1. A light absorption filter comprising:
a wavelength selective absorption layer containing a resin A having an acid group, and a dye; and
an adjacent layer directly disposed on at least one surface of the wavelength selective absorption layer,
wherein the adjacent layer contains a resin having a basic group.

2. The light absorption filter according to claim 1,
wherein the wavelength selective absorption layer contains a compound B that forms a hydrogen bond with the acid group contained in the resin A and generates a radical upon ultraviolet irradiation.

3. The light absorption filter according to claim 2,
wherein in the light absorption filter, the dye is chemically changed to be decolorized upon the ultraviolet irradiation.

4. An optical filter that is obtained by subjecting the light absorption filter according to claim 2 to mask exposure by ultraviolet irradiation.

5. An organic electroluminescent display device, an inorganic electroluminescent display device, or a liquid crystal display device, comprising:
the optical filter according to claim 4.

6. The organic electroluminescent display device, the inorganic electroluminescent display device, or the liquid crystal display device according to claim 5,
wherein a layer that inhibits light absorption of the compound B that generates the radical upon the ultraviolet irradiation is provided on a viewer side with respect to the optical filter.

7. A manufacturing method for an optical filter, comprising:
irradiating the light absorption filter according to claim 2 with an ultraviolet ray to carry out mask exposure.
